(19) United States
(12) Patent Application Publication
(10) Pub. No.: US 2012/0320040 A1
(43) Pub. Date: Dec. 20, 2012

(54) 3-D representation method and system

(75) Inventor: Cherif Atia Algreatly, Palo Alto, CA (US)

(73) Assignee: Cherif Atia Algreatly, Newark, CA (US)

(21) Appl. No.: 13/507,745

(22) Filed: Jul. 24, 2012

Related U.S. Application Data
(63) Continuation-in-part of application No. 12/462,715, filed on Aug. 7, 2009.
Application No. 12/462,715 is a continuation-in-part of application No. 12/072,976, filed on Feb. 29, 2008.

(51) Int. Cl. G06T 17/00; G06T 11/20

(52) U.S. Cl. 345/419; 345/441

(57) ABSTRACT

A method to represent a three-dimensional model with a plurality of joints where each one of these joints is automatically tagged with a number of IDs representing the name of its polygon, the position of the joint relative to a certain direction and the position of the joint relative to the other joints that surround it. This method enables the computer system to interpret the visual data of the 2D/3D model as usable information that can serve various fields and computer applications.

### CROSS-REFERENCE TO RELATED APPLICATION

This application is a Continuation-in-Part of co-pending U.S. patent applications Ser. No. 12/072,976, filed Feb. 29, 2008, titled “Graphical Data Mapping technique”, and Ser. No. 12/462,715, filed Aug. 7, 2009, titled “Computer Visions System and Language”.

### BACKGROUND

Computer graphics modeling is a widely used technology that serves a variety of fields and industrial applications. It creates detailed 3D models of organs in the medical field, 3D models of buildings and landscapes in the architectural field, 3D characters in real-life motion pictures in the movie industry and 3D models of new devices and machines in the manufacturing industry. Generally, there are three main techniques that are commonly used in the process of computer graphics modeling: constructive solid geometry, Non-Uniform Rational B-Spline (NURBS) modeling, and polygonal modeling. The constructive solid geometry (CSG) technique is based on creating a 3D model for an object by combining or de-combining a set of simple objects such as cubes, cylinders, spheres or cones. In this technique, the created 3D object may appear as a complex object but it is actually little more than a clever combination of such simple objects. This technique is used where simple geometric objects are desired or where mathematical accuracy is important. The NURBS modeling technique is a mathematical model commonly used for generating a plurality of curves to represent a freeform surface. It is usually used in computer-aided design (CAD) and computer-aided manufacturing (CAM). The polygonal modeling technique is an approach for modeling 3D objects by representing or approximating their surfaces using a collection of polygons, achieving faster representations than the other modeling methods. Accordingly, it is well-suited for real-time computer graphics use.

The output of the aforementioned three techniques is virtual objects that are later used in scenes on the computer display. The computer user usually interprets the visual data inherent in these virtual objects into useful information when s/he looks at the computer display while the computer system recognizes and perceives such visual data in a different manner than the computer user altogether. For example, presenting a detailed 3D model of a building on the computer display enables the computer user to recognize the number of the building's floors, the shapes of the building's spaces and the design style of the building. The computer system recognizes such 3D models as a collection of combined or de-combined objects in cases when the constructive solid geometry modeling technique is used, as a plurality of curves in cases when the NURBS modeling technique is used, or as sets of polygons in cases when the polygonal modeling technique is used. This different approach to abstract recognition between the computer user and the computer system for the presented 3D models on the computer display causes a real problem in interaction between the user and the computer. Accordingly, this problem limits the benefits and advantages of utilizing 3D modeling for many industrial applications.

### SUMMARY

The present invention of the 3D representation method and system introduces a solution for the aforementioned problem, enabling the computer system to interpret the visual data of the 2D/3D model as usable information that can serve various fields and applications. Accordingly, the present invention aids physicians in planning their medical surgeries in a structured and comprehensive manner. It also assists engineers to accurately analyze the structural designs of buildings against potential disasters such as earthquakes, hurricanes, or explosions. It helps software developers to create more intelligent 3D virtual environments for real-life motion pictures or for 3D gaming applications. Moreover, in design, the present invention enables the computer system to automatically generate the design solutions or alternatives for a visual design problem according to given constraints and requirements related to this design problem. This includes mechanical design, aerospace design, automotive design, architectural design, structural design, and many other design fields. Generally, in comparison with the traditional 3D modeling and design, the present invention dramatically saves the user's time and efforts in achieving his/her modeling and design tasks on the computer.

### BRIEF DESCRIPTION OF THE DRAWINGS

FIGS. 1 to 3 illustrate three different shapes comprised of a plurality of different grid units.

FIGS. 4 to 7 illustrate four simple grids comprised of identical grid units.

FIGS. 8 to 11 illustrate four complex grids comprised of identical grid units.

FIGS. 12 and 13 illustrate a plurality of identical grid units attached to each other in two different ways.

FIGS. 14 and 15 illustrate two grids in the form of concentric circles and octagons.

FIG. 16 illustrates a unit from an-octagonal grid.

FIGS. 17 and 18 illustrate two drawings successively created on a grid comprised of square units and a grid comprised of hexagonal units.

FIG. 19 illustrates a polygon drawn on a grid comprised of square units without aligning the polygon's lines to the grid's lines.

FIG. 20 illustrates small circles located on the vertices of a grid comprised of square units.

FIG. 21 illustrates surrounding each small circle with eight additional circles representing eight additional vertices.

FIG. 22 illustrates an imaginary cell positioned on top of each of the original vertices and each of the additional vertices.

FIG. 23 illustrates a rectangle drawn on a grid comprised of square units.

FIG. 24 illustrates eight arrows pointing out at the eight grid units that surround each original grid vertex.

FIGS. 25 to 31 illustrate the process of giving each cell (or grid unit) a number of IDs.

FIG. 32 illustrates a table indicating the conditions of additional IDs for the boundary joints and corner joints.

FIG. 33 illustrates the positions of the eight surrounding joints of a corner cell, a boundary cell, or an interior cell.

FIG. 34 illustrates the different IDs of the corner joints, boundary joints, and interior joints.

FIGS. 35 to 40 illustrate a number of polygons overlapping with each other.

FIGS. 41 to 43 illustrate two polygons (with similar characteristics) attached to each other.

FIGS. 44 to 46 illustrate two polygons (with different characteristics) attached to each other.

FIG. 47 illustrates two polygons intersecting with each other.

FIGS. 48 and 49 illustrate a hole and a polygon intersecting and attached to each other.

FIGS. 50 and 51 illustrate a number of polygons that intersect with each other forming an interior void and an exterior void.

FIG. 52 illustrates a number of polygons overlapping with each other.

FIG. 53 illustrates the composition database according to one embodiment of the present invention.

FIGS. 54 to 55 illustrate an example for identifying points in a drawing according to certain criteria using the present invention.

FIGS. 56 to 59 illustrate an example for identifying lines in a drawing according to certain criteria using the present invention.

FIGS. 60 to 69 illustrate an example for identifying areas in a drawing according to certain criteria using the present invention.

FIGS. 70 to 76 illustrate examples of positioning polygons in a drawing according to certain criteria using the present invention.

FIGS. 77 to 78 illustrate an example for positioning polygons according to certain requirements using the present invention.

FIGS. 79 to 82 illustrate an example for positioning polygons according to certain requirements using the present invention.

FIGS. 83 to 91 illustrates the IDs of the joints for 3D models according to one embodiment of the present invention.

FIGS. 92 to 97 illustrate examples of design solutions for an architectural design problem (in 3D) using the present invention.

FIG. 98 illustrates an example of a complex 3D model that can be analyzed using the present invention.

### DETAILED DESCRIPTION

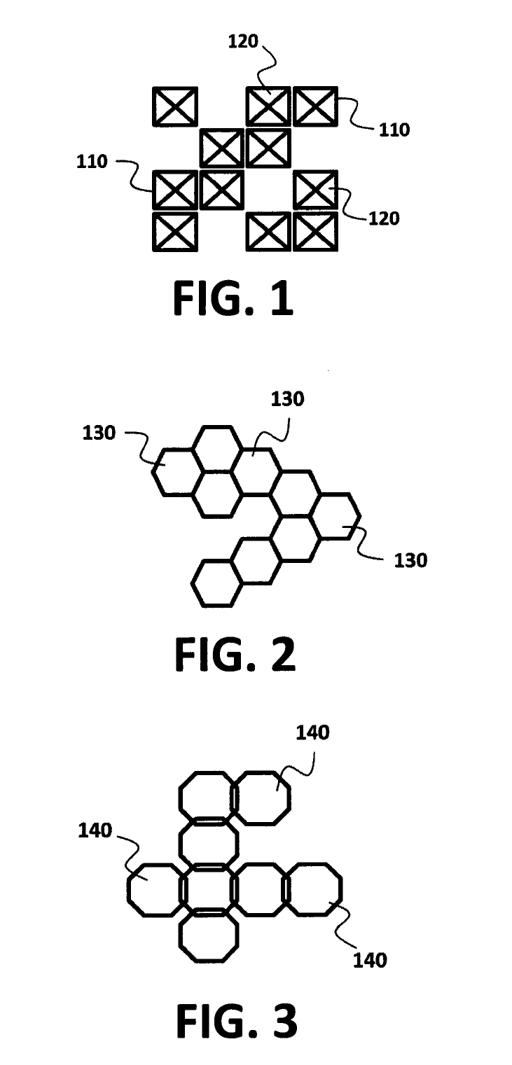

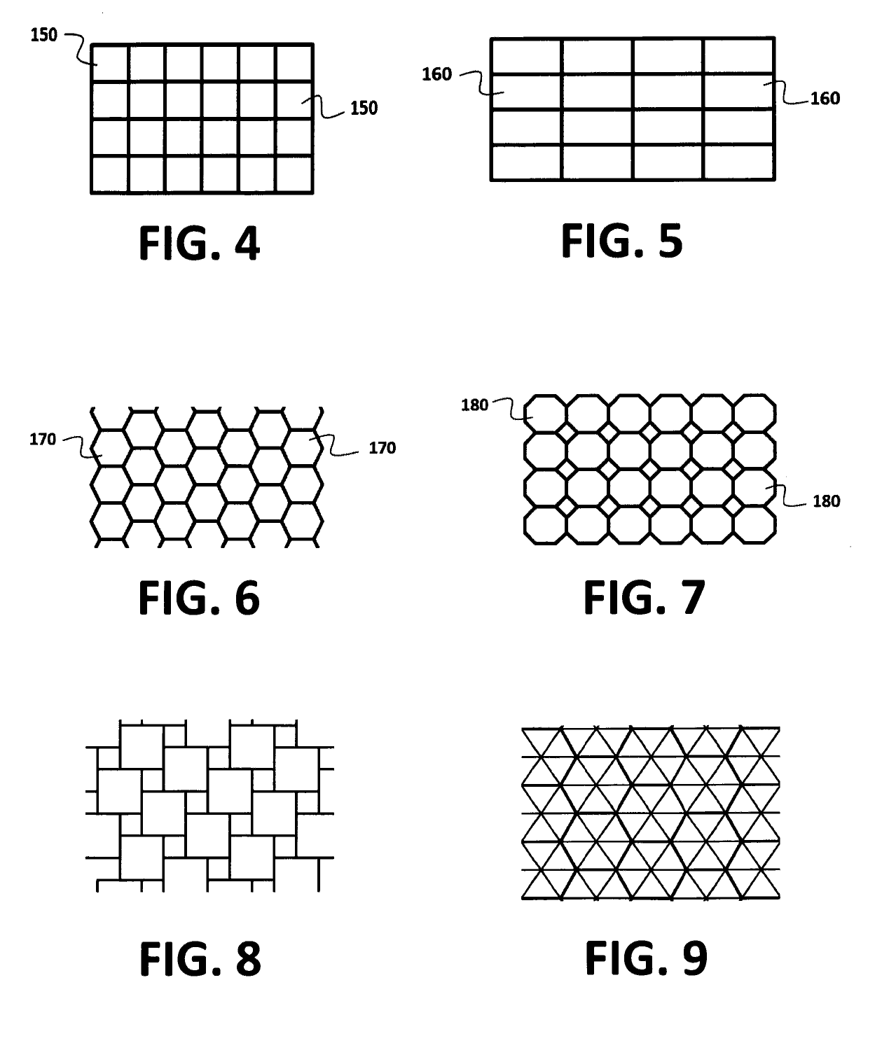

One of the common methods of describing a complex shape is to identify the units that this shape is comprised of. For example, FIGS. 1 to 3 illustrate three different shapes that are hard to describe without mentioning that the first shape is comprised of separate squares 110 divided into a number of identical triangles 120, the second shape is comprised of attached hexagons 130 and the third shape is comprised of overlapping octagons 140. In this primary description we mentioned names of basic shapes or units such as squares, hexagons, or octagons. We also mentioned dividing these units in addition to attaching or separating them to/from each other. In fact, these are four parameters that enable the creation of thousands of grids that can be used in design. Generally, the grid is a plurality of identical units that are repeated in a certain fashion in two or three dimensions. Any polygon can be utilized as a grid unit although there are certain polygons that are more common than others in grids. For example, squares and rectangles are the most common grid units that are utilized in design. FIGS. 4 to 7 illustrate four simple grids successively utilizing square grid units 150, rectangular grid units 160, hexagonal grid units 170 and octagonal grid units 180 that are attached to each other in a simple way.

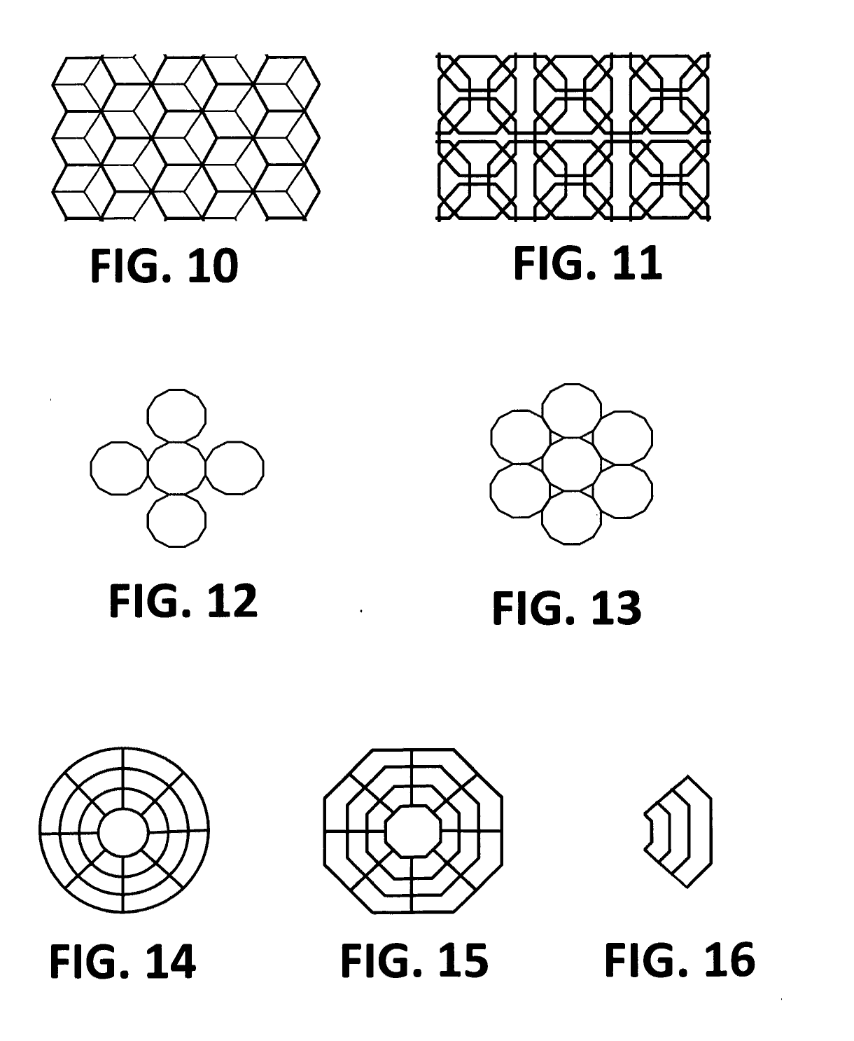

Generally, one of the methods that help creating thousands of grids is to answer the following four questions in different ways: which grid unit will be used?; how will it be divided?; how the grid units will be attached to each other?; and what distances will they be positioned in relative to each other? For example, the grid unit can be any shape with a certain number of equal sides such as 4, 6, 8, 12, 16, or 24 and this shape can be divided into a number of identical parts. For example, the square can be divided into two or four identical parts while the hexagon can be divided into two, three, or six identical parts. The sides of each two successive units can be attached to each other from 0% to 100%, where the zero value represents the two sides of the two successive units meeting at one point or corner, while the 100% value represents the two sides of the two successive units completely overlapping with each other. The distance between each two successive units can be a positive or negative value, the positive value representing the two successive units not intersecting with each other, while the negative value representing each two successive units intersecting with each other. Generally, FIGS. 8 to 11 illustrate examples of different grids where each one of them is based on different answers to the aforementioned four questions.

A common category of grids utilizes a grid unit with a number of sides equal to “4n” or “6n” where “n” is a positive integer. For example, the grid units of 4, 8, 12, 16 sides and the grid units of 6, 12, 18, 24 sides are examples of those common grids. The grid unit type “4n” is attached to each other in four directions, the way the squares of FIG. 4 are attached to each other. The grid unit type “6n” is attached to each other in six directions, the way the hexagons of FIG. 6 are attached to each other. The grid units that have a number of sides that can be divided by 4 or 6 such as 12, 16, or 18, can be attached to each other in four or six directions. For example, FIGS. 12 and 13 illustrate grid units with 12 sides that can be attached to each other in four or six directions. Generally, as shown in all previous examples, it is more common to have the unit sides identically positioned relative to each other. However, there are some other types of grids that are different from the previous examples in positioning the grid units relative to each other. For example, FIG. 14 illustrates one of these different grids that take a circular form. As shown in this figure, the size of each grid unit changes according to its position relative to a center point. FIG. 15 illustrates another grid similar to the previous one but the circles are replaced with concentric octagons. FIG. 16 illustrates the grid units of FIG. 15 where each one of these units is divided into two identical parts as shown in FIG. 15. Generally, there are other types of more complex grids that are not mentioned since these types of grids are not common. The unit of such complex grids is comprised of a plurality of polygons attached to each other in a certain way instead of using one polygon only as a grid unit as shown in the previous figures.

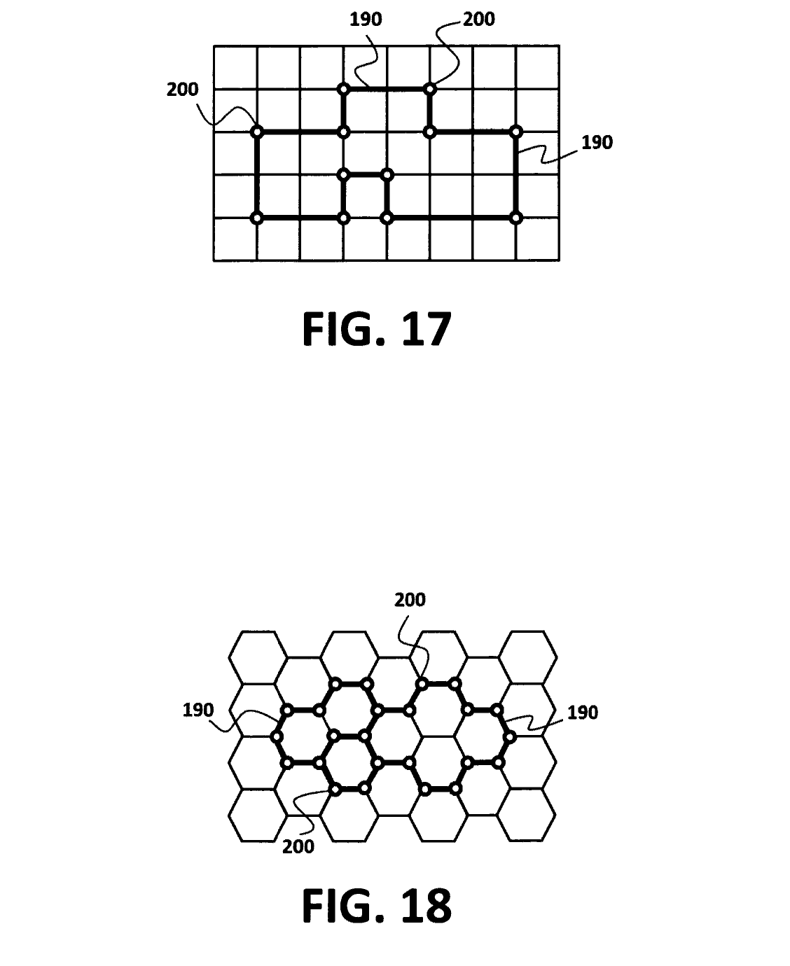

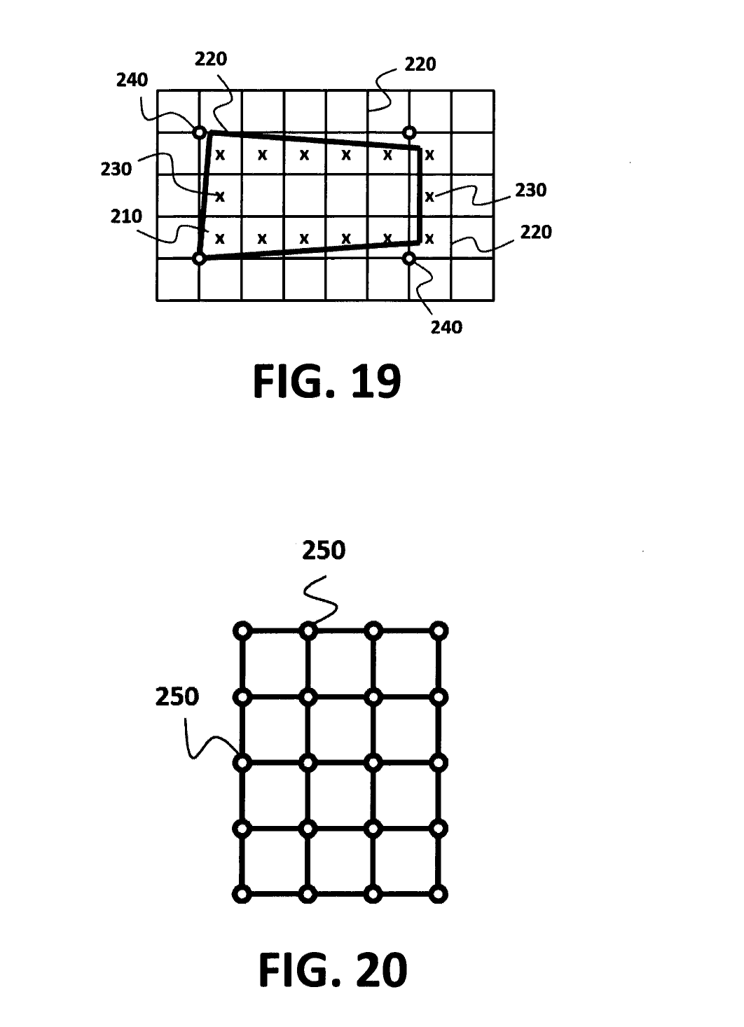

Generally, the grids enable creating 2D/3D models in a manner that simplifies any subsequent process. For example, FIGS. 17 and 18 illustrate two drawings successively created on a square grid and a hexagonal grid, as shown in these two figures, the drawing lines 190 are aligned with the sides of the grid units. However, in real life, all objects have a width, and accordingly, in accurate modeling, each object can be represented by one or more polygons, where no object can be represented by one line. Generally, most 2D/3D models are comprised of one or more polygons where each polygon can be defined by its vertices. For example, the small circles 200 in FIGS. 17 and 18 represent the vertices of the drawn polygons that mathematically define these polygons. It is important to note that the vertices of the drawn polygons are located on the vertices of the grid units; accordingly, each drawing can be represented by a plurality of grid vertices as will be described subsequently. However, not all drawings can be aligned to the lines of the grid units. In this case, the lines of the drawn polygon are approximated to the closest vertices of the grid units. For example, FIG. 19 illustrates a polygon drawn on a square grid where the polygon lines 210 do not align with the squares lines 220. As shown in the figure, the marked squares 230 represent the grid units that intersect with this polygon while the small circles 240 represent the vertices of the grid units that approximately represent this polygon. In such cases, decreasing the size of the grid units enables representing the polygon in a more accurate manner. Generally, this method of converting each line of a polygon into a number of squares that represent the line is somehow similar to the method of presenting the drawings on the computer display using pixels.

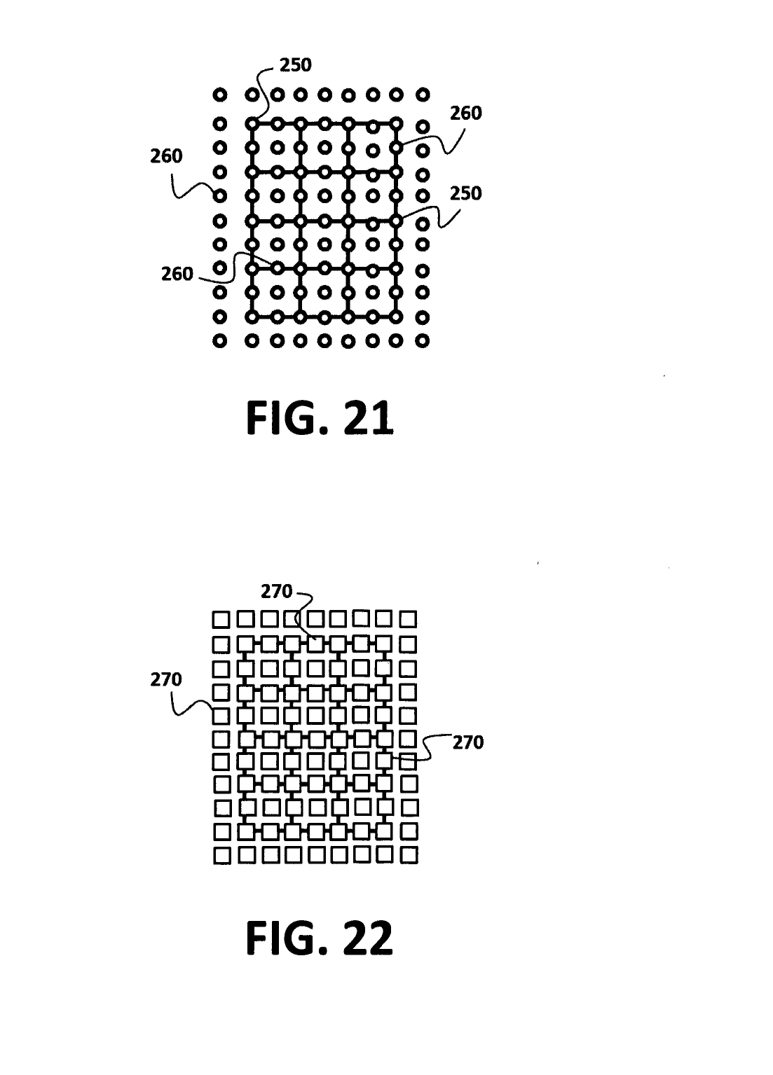

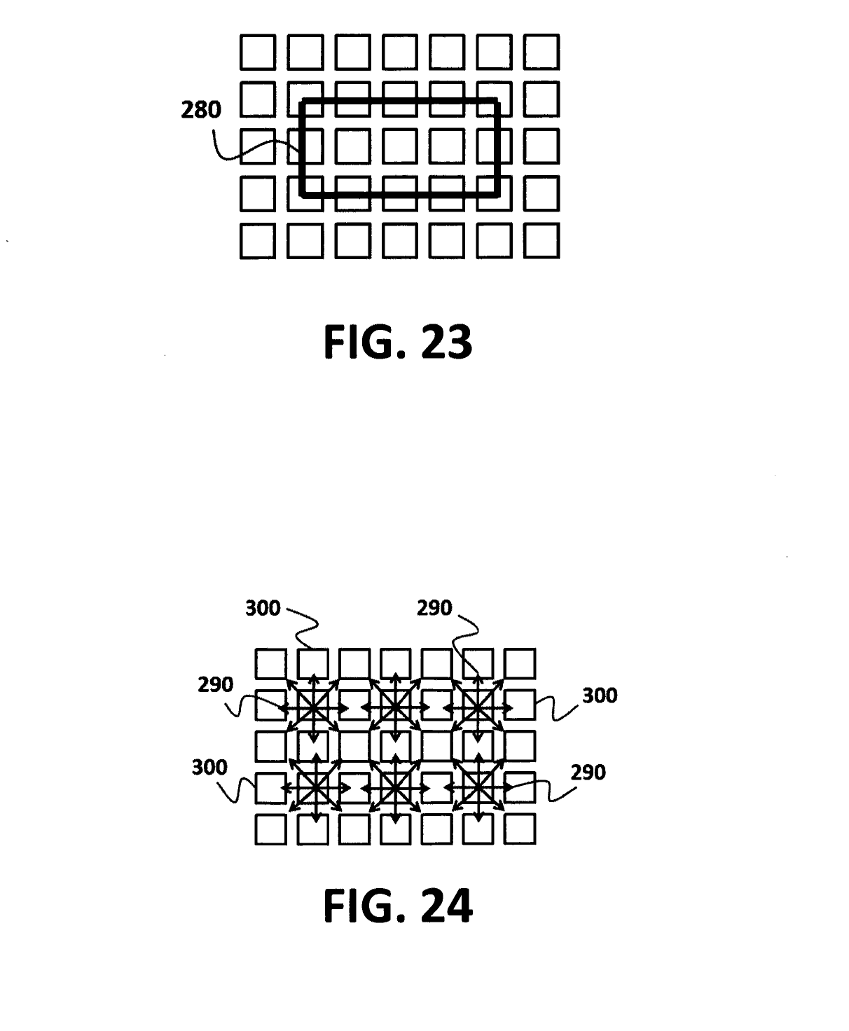

In one embodiment of the present invention, as will be described subsequently, the square grid is utilized with the drawings that didn't utilize grids in its creation. However, in some cases, although the drawing didn't utilize a grid in its creation, this drawing can still be aligned with a specific grid that has certain unit dimensions. Generally, as described previously, each drawing that represents a real object is comprised of one or more polygons where each polygon can be represented by a number of vertices of grid units. In one embodiment of the present invention, each one of these grid vertices can be given a unique ID representing the part of the drawing that is located on it. To achieve that, each vertex of a grid unit is associated with an imaginary cell that can carry this ID. For example, FIG. 20 illustrates a square grid where each square vertex is indicated with a small circle 250. FIG. 21 illustrates the surrounding of each small circle 250 with another eight additional circles 260 representing eight additional vertices. FIG. 22 illustrates an imaginary cell 270 positioned on top of each original vertex and additional vertex to carry the IDs of these vertices. The concept of giving an ID to each imaginary cell to represent the part of the drawing that is located on a vertex is based on comparing each imaginary cell with the eight cells that surround it. For example, FIG. 23 illustrates a rectangle 280 drawn on a square grid, while FIG. 24 illustrates eight arrows 290 pointing out at the eight cells 300 that surround each original grid vertex. Generally, each ID given to an imaginary cell of a vertex represents the different combination of the eight surrounding cells of the vertex as will be described subsequently.

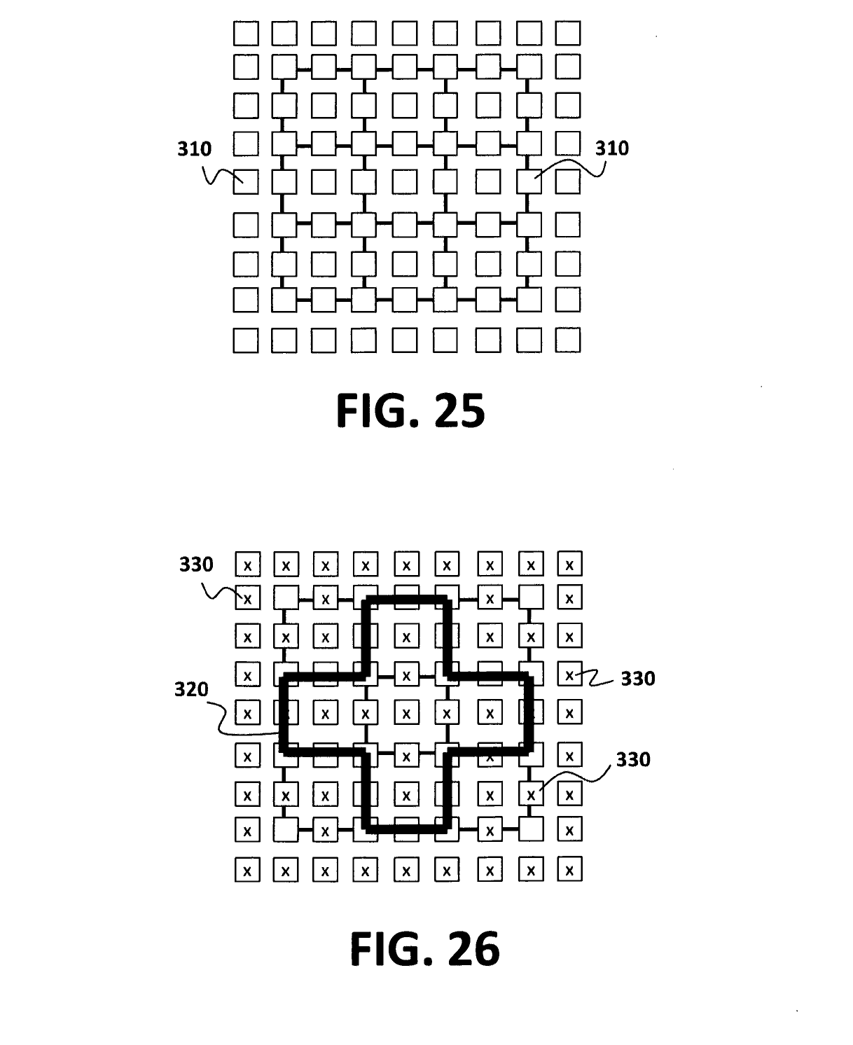

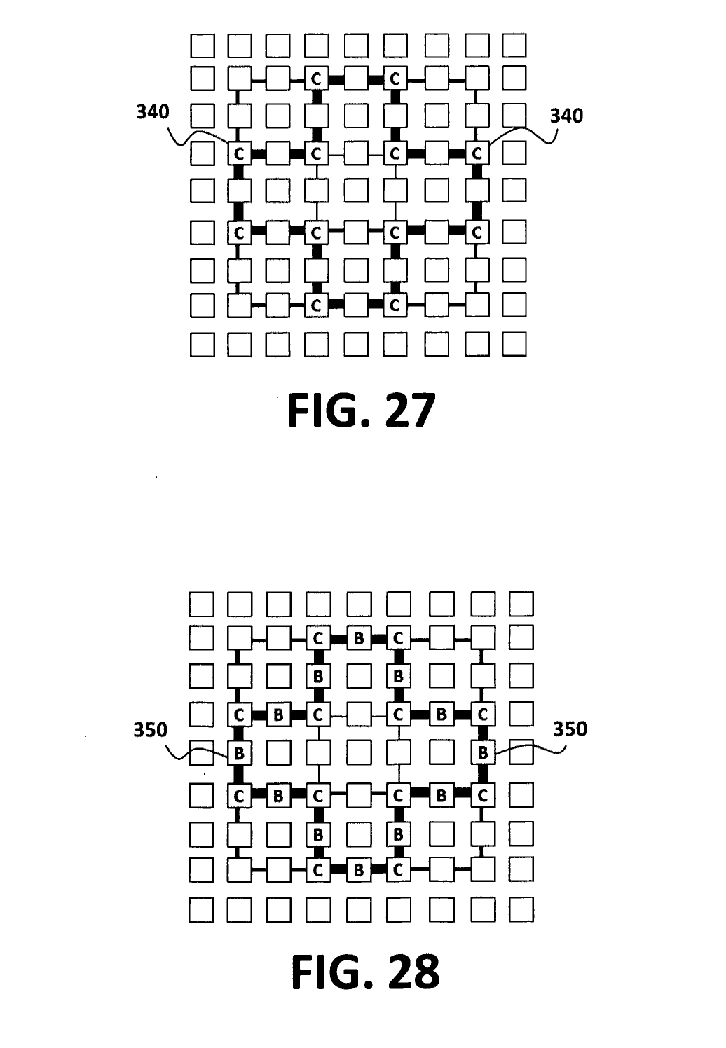

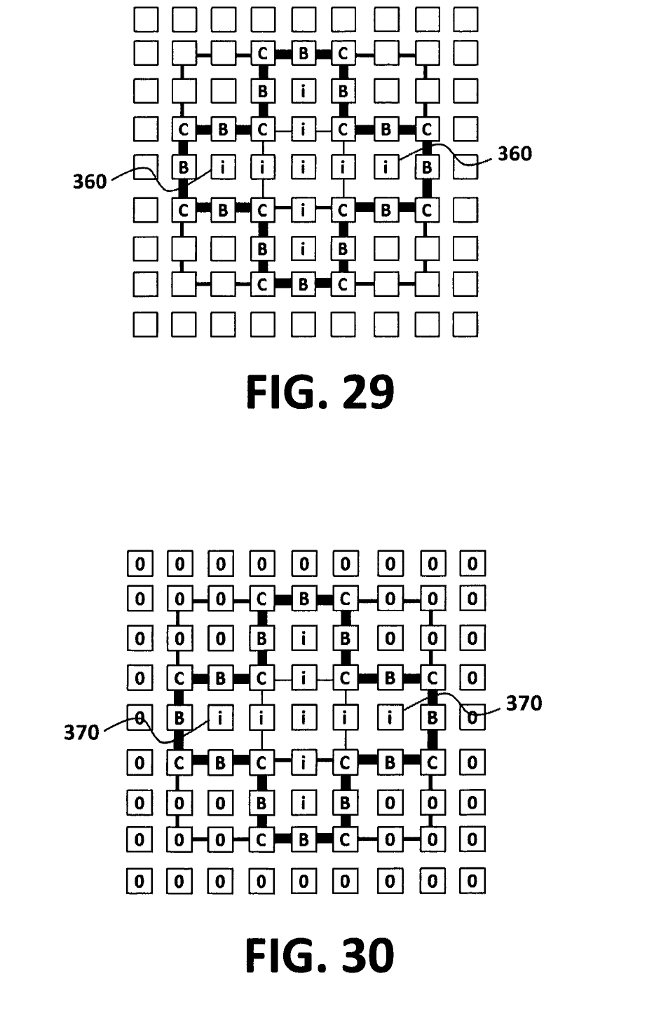

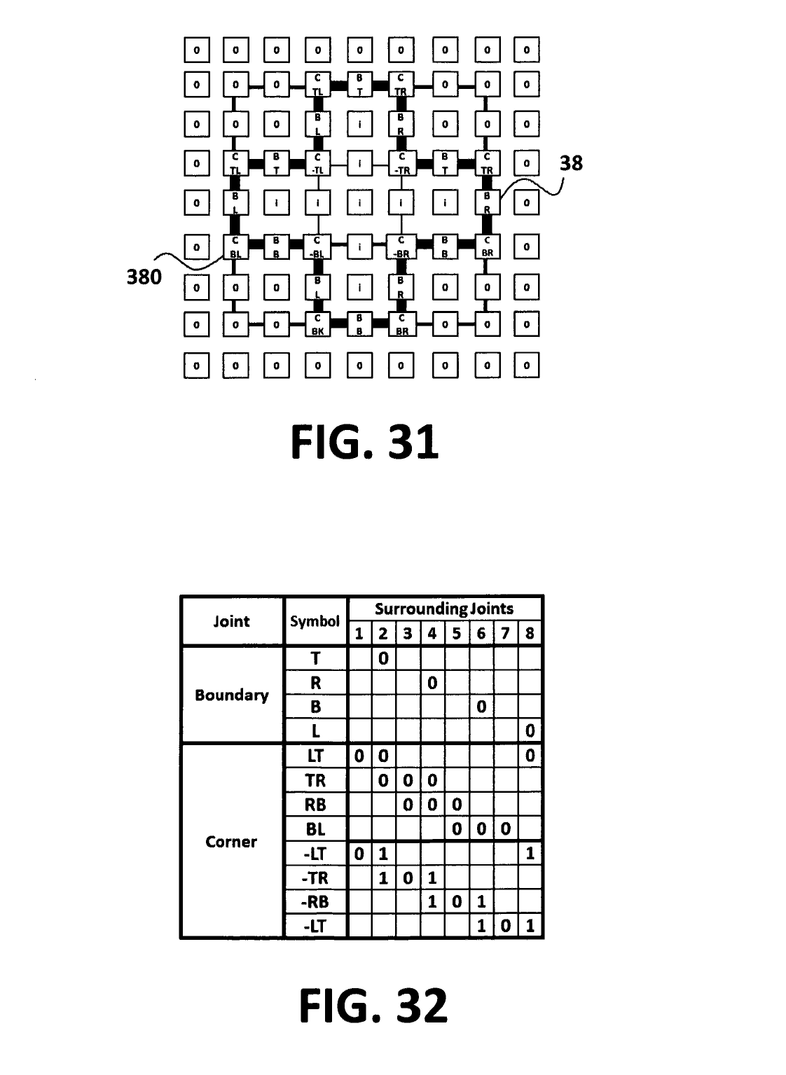

In another embodiment of the present invention, as shown in FIG. 25, a square grid with its imagery cells 310 is illustrated, while FIG. 26 illustrates a polygon 320 drawn on this grid. As shown in the figure, the polygon lines never start or end at the additional vertices 330 which are represented in the drawing by the cell tag “x” where these additional vertices are not part of the grid vertices. FIG. 27 illustrates tagging each cell located on a polygon vertex 340 with “C” as an indication for a corner joint, while FIG. 28 illustrates tagging each cell 350 located between each two successive corner joints with “B” as an indication for a boundary joint. FIG. 29 illustrates tagging each cell 360 located inside the polygon with an “i” as an indication for an interior joint, while FIG. 30 illustrates tagging all other cells 370 of the grid with the numeral “zero” as an indication for an empty cell that is located outside the polygon. In one embodiment of the present invention, as shown in FIG. 31, an additional ID 380 is given to each corner joint and boundary joint representing its position relative to its eight surrounding cells. For example, the boundary joints of the polygon that are located on the top, right, bottom, and left sides of the polygon are successively given the additional IDs or tags T, R, B, and L. Accordingly, the corner joints of the polygon are given the additional tags TL, TR, BR, BL, −TL, −TR, −BR, and −BL. Each negative symbol of a corner joint indicates that the corner joint is located on two boundary lines meeting at 90 degrees from the side of the empty joints. If the corner joint does not include a negative symbol that means this corner joint is located on two boundary lines meeting at 270 degrees from the side of the empty joints. It is important to note that the interior joints and the empty cells are not given additional IDs as shown in the figure.

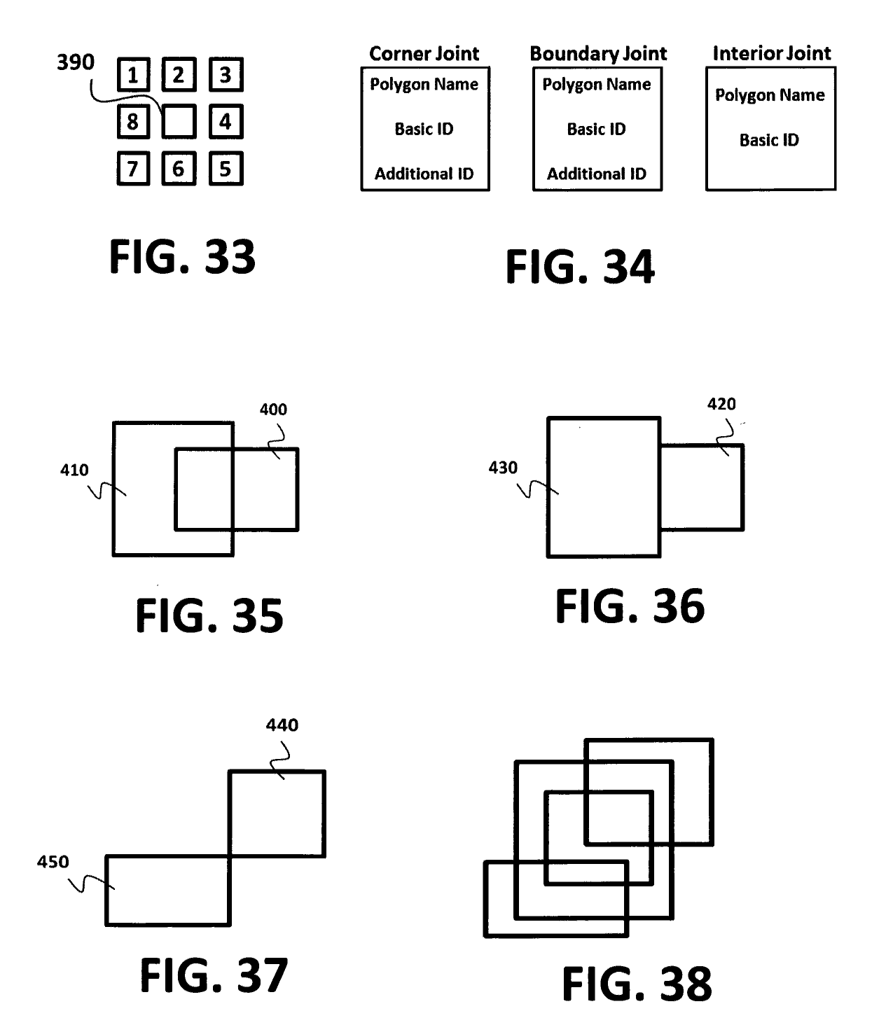

Generally, to create an additional ID for a boundary joint or a corner joint, each one of the eight surrounding cells of the boundary joint or the corner joint is checked according to the table of FIG. 32. The positions of the eight surrounding joints 1 to 8 of a corner cell, boundary cell, or an interior cell are illustrated in FIG. 33. The numeral “zero” in the table represents an empty cell while the numeral “1” in the table represents a filled cell. The table cells that do not include “zero” or “1” represent a joint or a cell that does not affect the creation of the additional ID. In one embodiment of the present invention, as described previously, each one of the boundary joints and the corner joints carries a basic ID and an additional ID, while the interior joints carry only a basic ID. In another embodiment of the present invention, there is another ID given to the polygon's joints representing the name of the polygon. Accordingly, the boundary joints and the corner joints of the polygon will successively carry the polygon's name, the basic ID and the additional ID, while the interior joints will only carry the polygon's name and the basic ID as illustrated in FIG. 34.

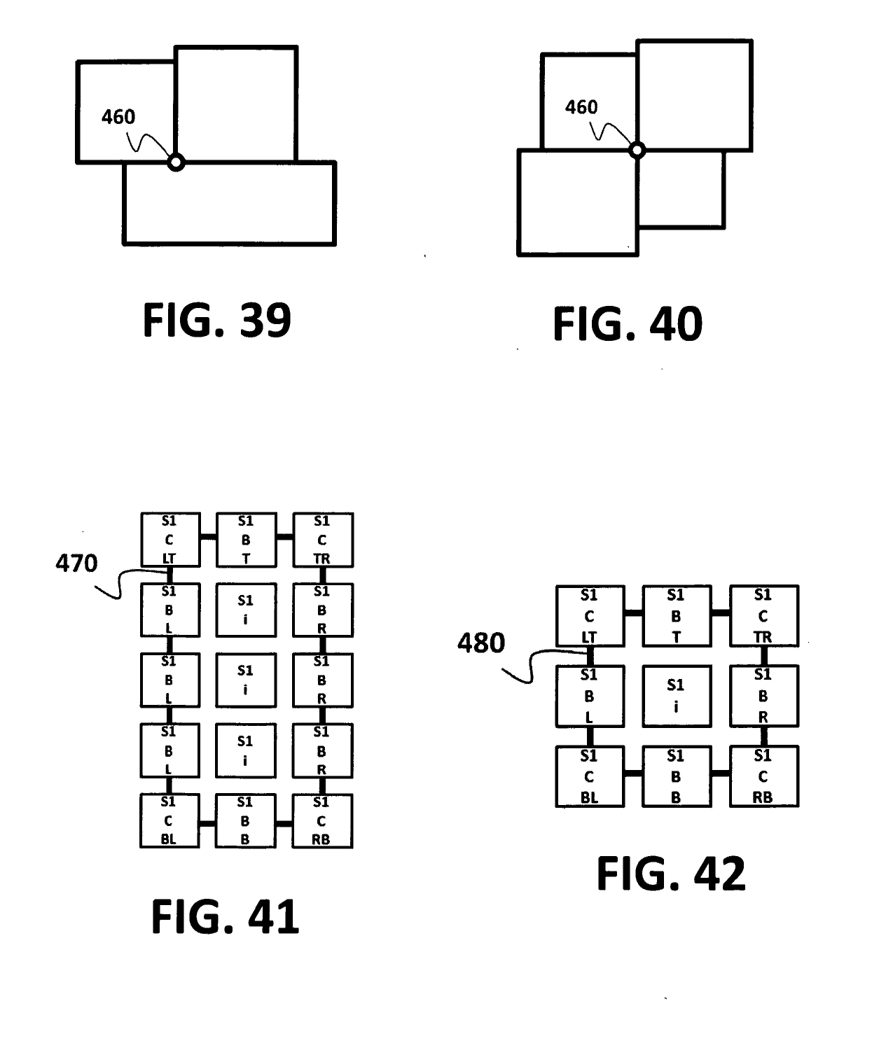

In one embodiment of the present invention, when polygons overlap each other in an area, line, or point, the overlapped joints change their IDs according to the type of overlapping and the names of the overlapped polygons. Generally, in this document, if two polygons are overlapped in an area, then this overlapping will be called an “intersection”; in cases where the two polygons are overlapped on a line or a point, then this overlapping will be called an “attachment”. For example, FIG. 35 illustrates two polygons 400 and 410 intersecting with each other, while FIG. 36 illustrates two polygons 420 and 430 attached to each other on a line, and FIG. 37 illustrates the two polygons 440 and 450 attached to each other at a point. As will be described subsequently, in some cases, if the polygons represent real objects, then they cannot be intersected with each other, while if the polygons represent zones or imaginary spots, then they can be intersected with each other as shown in FIG. 38. Also if the polygons represent real objects, then only three or four polygons can be attached to each other at one point as indicated by the small circle in FIGS. 39 and 40.

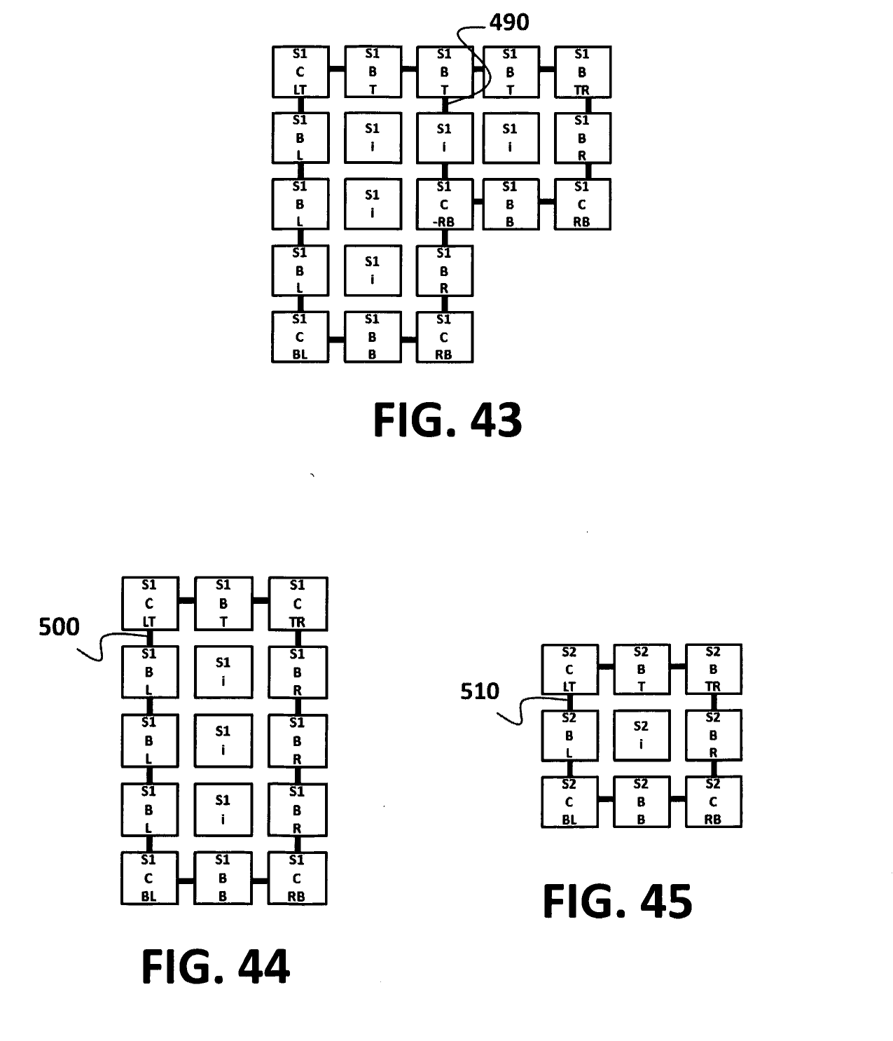

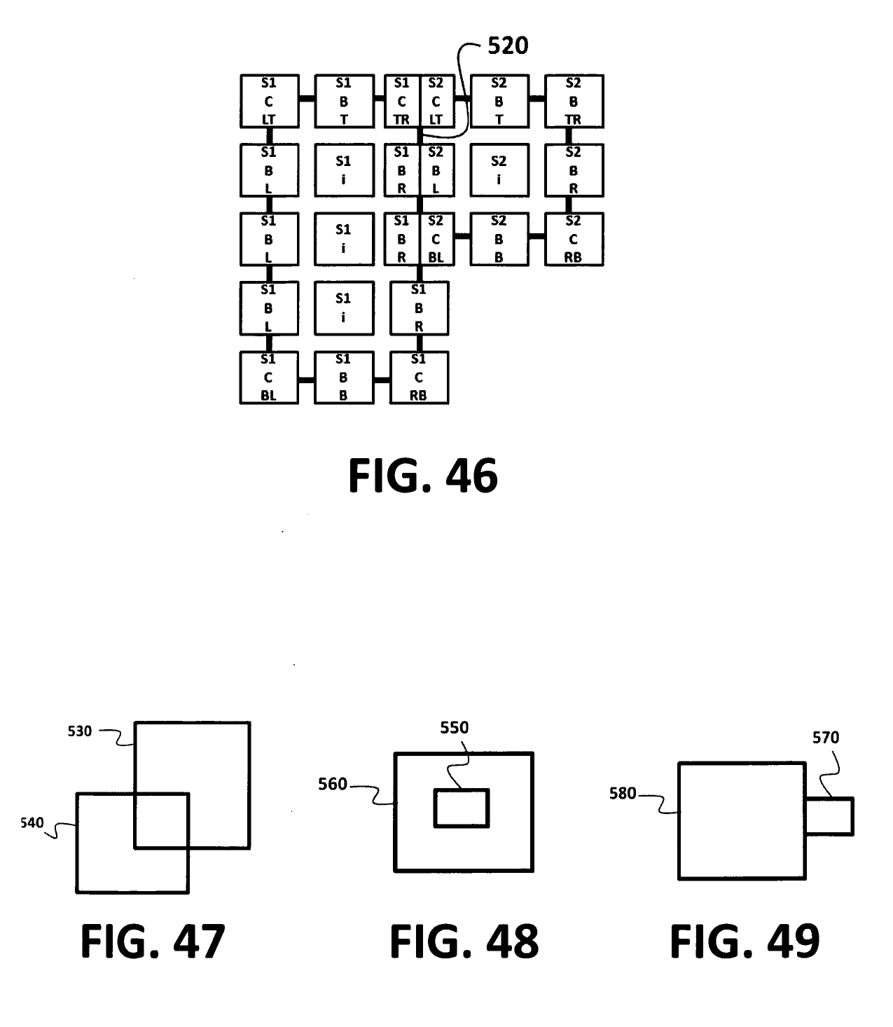

FIGS. 41 and 42 successively illustrate a first polygon 470 and second polygon 480 with the same tagged name “S1”, while FIG. 43 illustrates attaching these two polygons to each other in a line 490. In one embodiment of the present invention, as shown in the figure, each joint, located on the first and second overlapped polygons, changes its basic ID and additional ID to suite its position relative to the new eight surrounding cells. In other words, each joint located on the attachment line is checked again relative to the eight cells that surround it in order to generate its new IDs. The same rule applies if the two polygons (with the same name) intersect in an area or if more than two polygons (with the same name) are attached or intersect to/with each other. FIGS. 44 and 45 successively illustrate a first polygon 500 and second polygon 510 with two different names “S1” and “S2”, while FIG. 46 illustrates attaching these two polygons to each other on a line 520. In one embodiment of the present invention, as shown in the figure, each joint located on the first and second overlapped polygons carries the two names, the two basic IDs, and the two additional IDs of the two polygons. Generally, the same rule applies if the two polygons with different names intersect with each other in an area or if more than two polygons with different names are attached or intersect to/with each other.

Generally, when two polygons or more intersect with each other, the area of intersection forms a new polygon. In one embodiment of the present invention, the corner joints, the boundary joints and the inner joints of this new polygon are identified. For example, FIG. 47 illustrates two polygons 530 and 540 named “S1” and “S2” intersecting with each other where the corner, boundary and inner joints of this area of intersection or polygon can be identified as follows: the corner joint of the area of intersection is a joint that has two names and also is a corner joint in S1 or S2, or is attached to a joint that does not carry S1 or S2; the boundary joint of this area of intersection is a joint that has two names and is also a boundary joint in S1 or S2 that is not attached to a joint that does not carry S1 or S2; the inner joint of this area of intersection is a joint that has two names and is an inner joint in S1 and S2. Subtracting the joints of the intersection area from each of the two polygons defines the parts of the two polygons that are located outside the area of intersection. In one embodiment of the present invention, the aforementioned described steps are done on each drawing to define each area of intersection, and each part of a polygon that is located outside an area of intersection in a drawing as will be described subsequently.

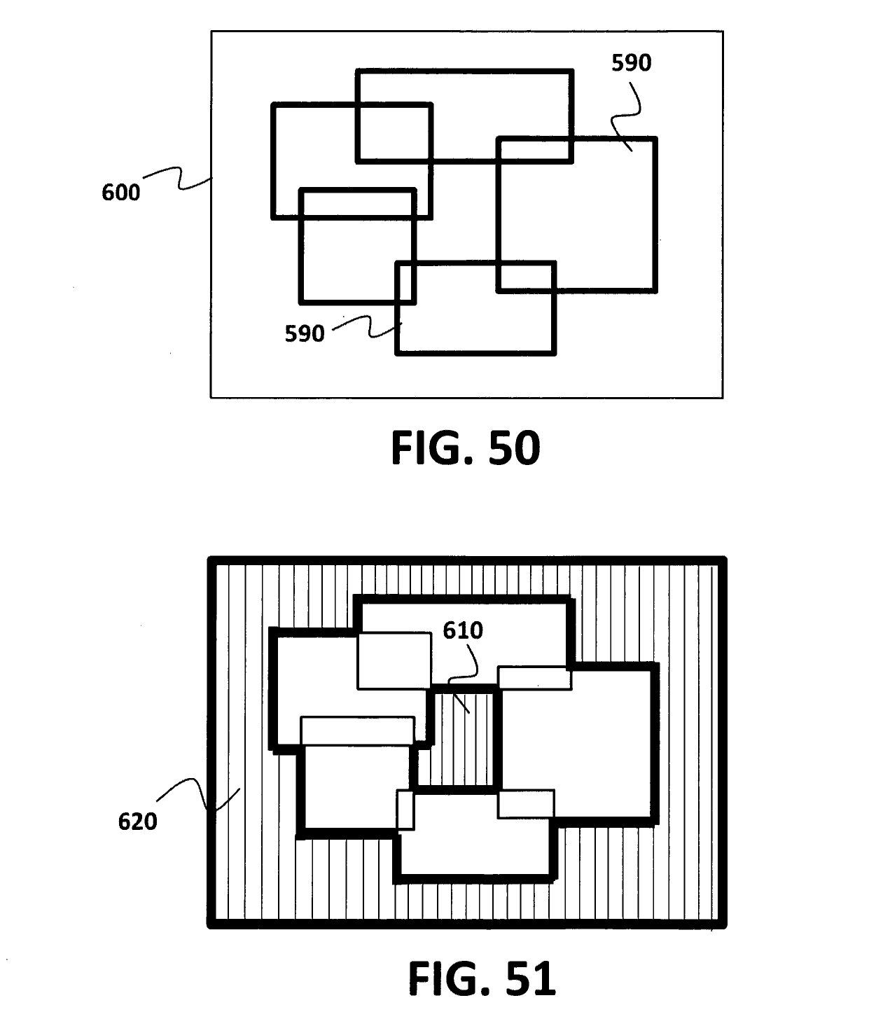

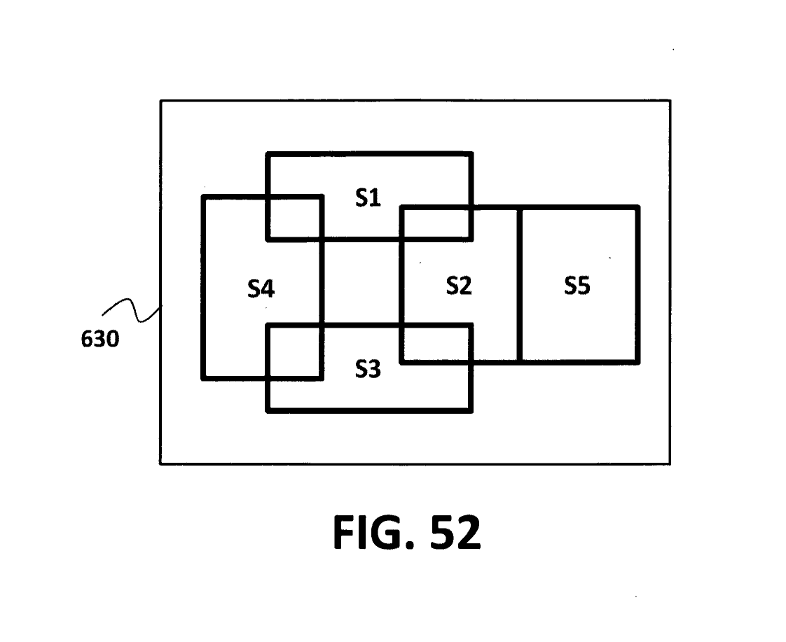

In another embodiment of the present invention, in cases where there is a polygon that represents a hole or void, then each joint of this polygon will also carry a tagged hole name, a basic ID and an additional ID. For example, FIG. 48 illustrates a hole 550 overlapped with a polygon 560; in this case, the inner joints of the hole that are overlapped with the polygon will only include the name of the hole, while the boundary joints of the hole that are overlapped with the polygon will include both the names of the hole and the other polygon. FIG. 49 illustrates a hole 570 attached to a polygon 580; in this case, the boundary joints of the hole that are attached to the polygon will carry both the names of the hole and the polygon. In one embodiment of the present invention, in addition to creating a polygon representing a void in a drawing, there are other two types of voids that usually appear in drawings. The first one is the interior voids which are surrounded by a cluster of polygons, and the second one is the exterior voids which are located outside the cluster of polygons. For Example, FIG. 50 illustrates a drawing comprised of a number of intersected polygons 590 on the computer display 600, while FIG. 51 illustrates the interior void 610 and the exterior void 620 of this drawing that are filled with vertical lines.

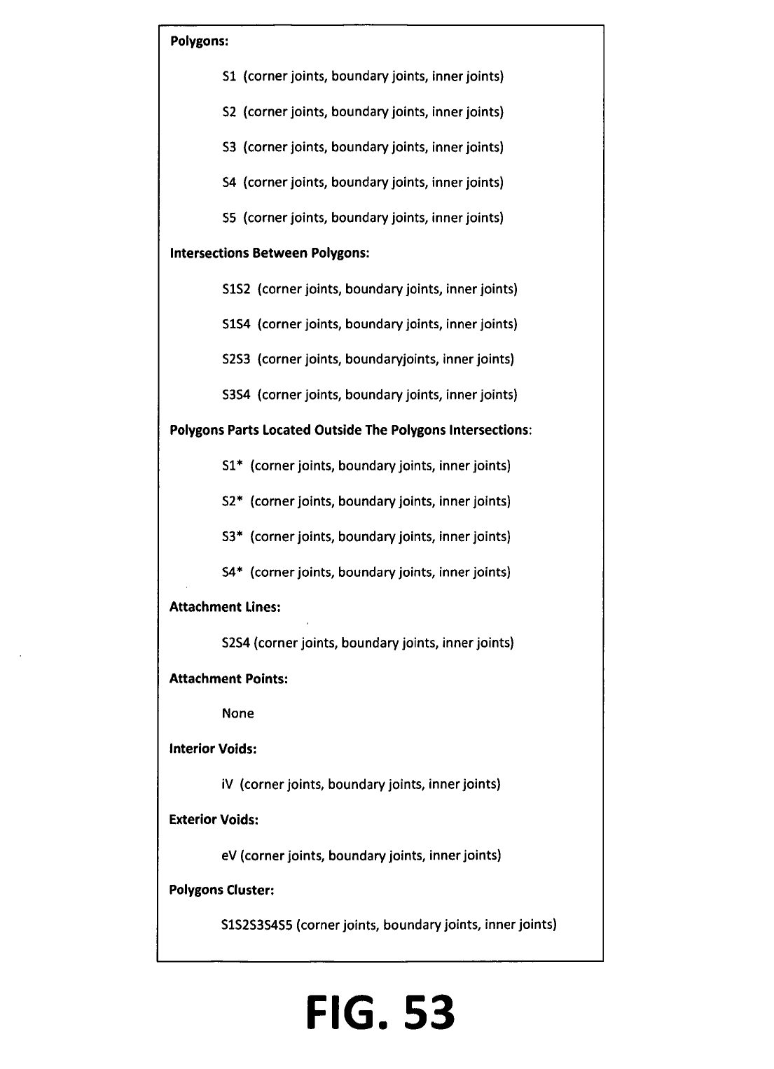

In one embodiment of the present invention, defining the exterior voids, the interior voids, the intersection areas, and the polygon parts that are located outside the intersection areas(in addition to the attachment lines and the attachment points) enables forming a composition database that represents the different parts of the drawing. For example, FIG. 52 illustrates a drawing comprised of five polygons S1, S2, S3, S4 and S5 that intersect and/or attach with/to each other on the computer display 630, while FIG. 53 illustrates the composition database of this drawing. As shown in the figure, this composition database is comprised of polygons, intersections between polygons, polygon parts located outside the polygons' intersections, attachment lines, attachment points, interior voids, exterior voids and polygon clusters where all these elements of the composition database are described by corner joints and boundary joints. In this figure, for example, S1S2 represents the intersection area between the two polygons S1 and S2, while S1S4 represents the intersection area between the two polygons S1 and S4. S1* represents the area of polygon S1 that is located outside the intersections between polygon S1 and the two polygons S2 and S4. iV represents the interior void while eV represents the exterior void. The polygon cluster in the composition list represents all joints of polygons that form one cluster, in other words, all polygons that are intersect or attach to each other and are surrounded with an exterior void.

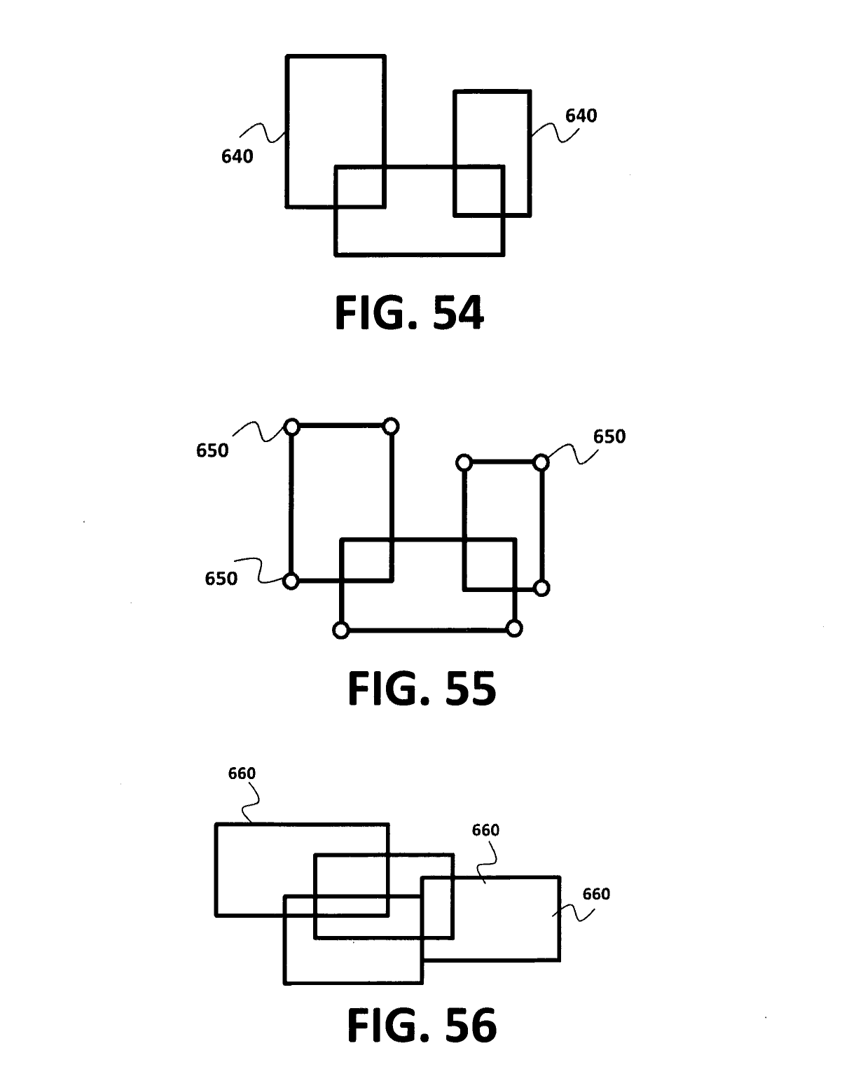

In drawings when using the traditional geometry there is always a need to figure out the positions of certain points that meet certain criteria. Usually there are three probabilities or cases when dealing with such problems. The first case is finding an algorithm that enables quickly reaching the solution on the computer. This happens when the problem is simple and the number of drawing lines is limited. The second case is finding an algorithm that enables reaching the solution slowly on the computer. This happens when the problem is simple but the number of drawing lines is big. The third case is failing in finding an algorithm or solution although we can manually point out such points on the drawing. As we can see in these three cases, there is a first problem related to the speed of the solution on the computer and a second problem related to converting a manual solution into an algorithm. On the other hand, when using the present invention, we get the three advantages: the first advantage is speeding up the solutions on the computer regardless of the number of drawing lines; the second advantage is providing a systematic approach that simply enables translating the manual solution into a programming language; and the third advantage is reducing the deceiving solutions, where the deceiving solution can be defined as a solution for some cases of the problem that the user considers to be a general solution for the problem. For example, FIG. 54 illustrates a number of rectangles intersecting with each other where it is requested to find the rectangle corners that have an exterior exposure. In this case when using the present invention, the rectangle corners that have an exterior exposure can be simply defined as the polygon corners that are located on the joints of the exterior void, as indicated in FIG. 55 with the small circles 650.

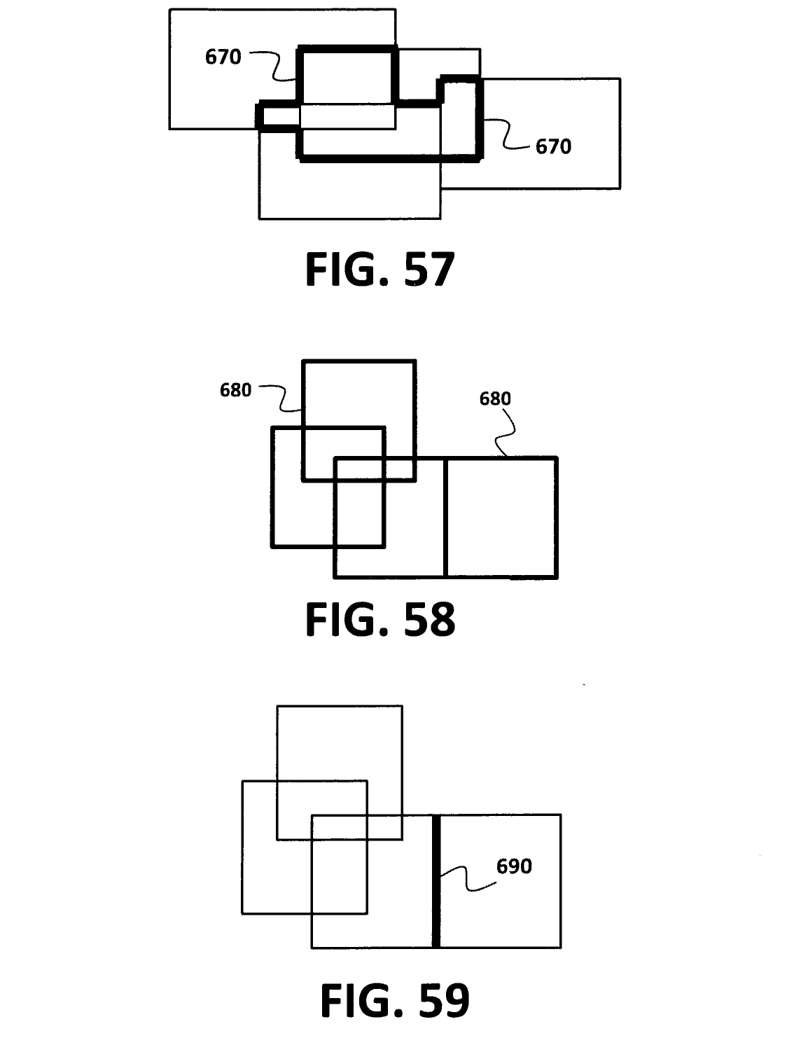

In one embodiment of the present invention, the line is represented by a plurality of successive joints. Accordingly, to find out a line in a drawing that meets certain criteria we need to figure out the joints that this line is comprised of However, the difficulty in finding certain points in drawings when using traditional geometry is the same when finding certain lines in drawings. On the other hand, the simplicity in finding certain points in drawings when using the present invention is the same when finding certain lines in drawings. For example, FIG. 56 illustrates a number of polygons 660 overlapping with each other where it is requested to define the lines that represent the exterior boundary of the overlapping area between the polygons. In this case when using the present invention, these lines can be represented by the corner and boundary joints of the exterior void that are also corner or boundary joints of polygons, as indicated in FIG. 57 with the thick lines 670. FIG. 58 illustrates another example presenting a plurality of polygons 680 overlapping with each other where it is requested to find the vertical attachment lines of these overlapped polygons using the present invention. In this case, the vertical attachment lines can be defined as the attachment lines that have two joints with the same y-coordinate, as indicated with the thick line 690 in FIG. 59.

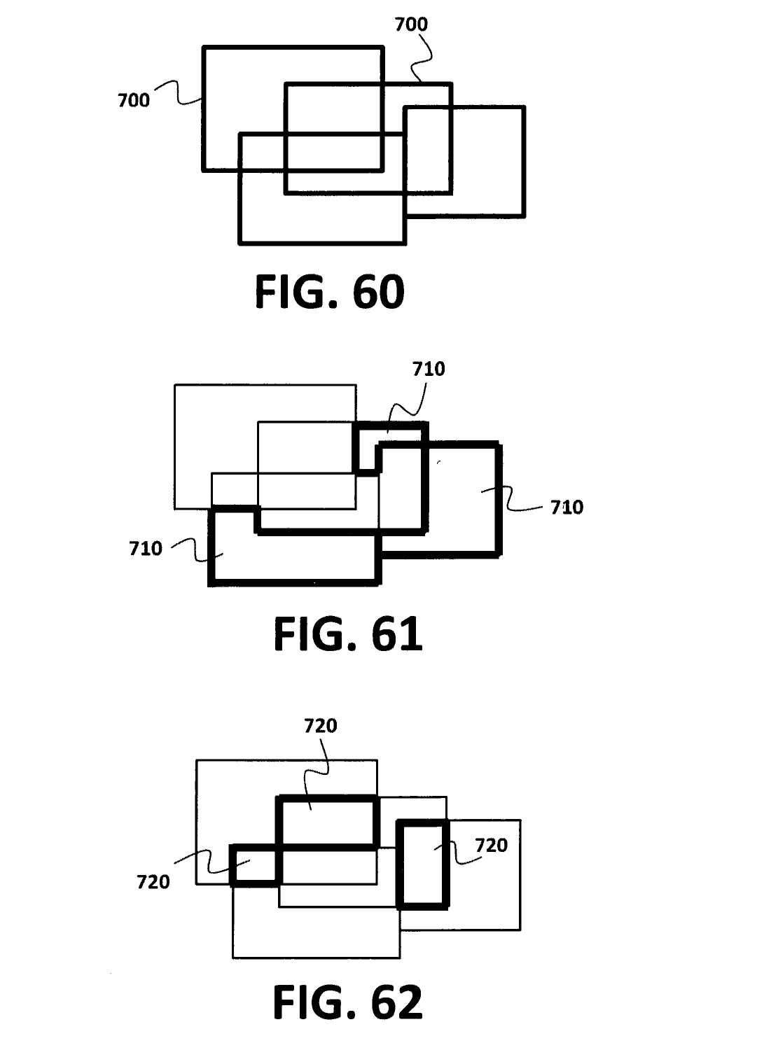

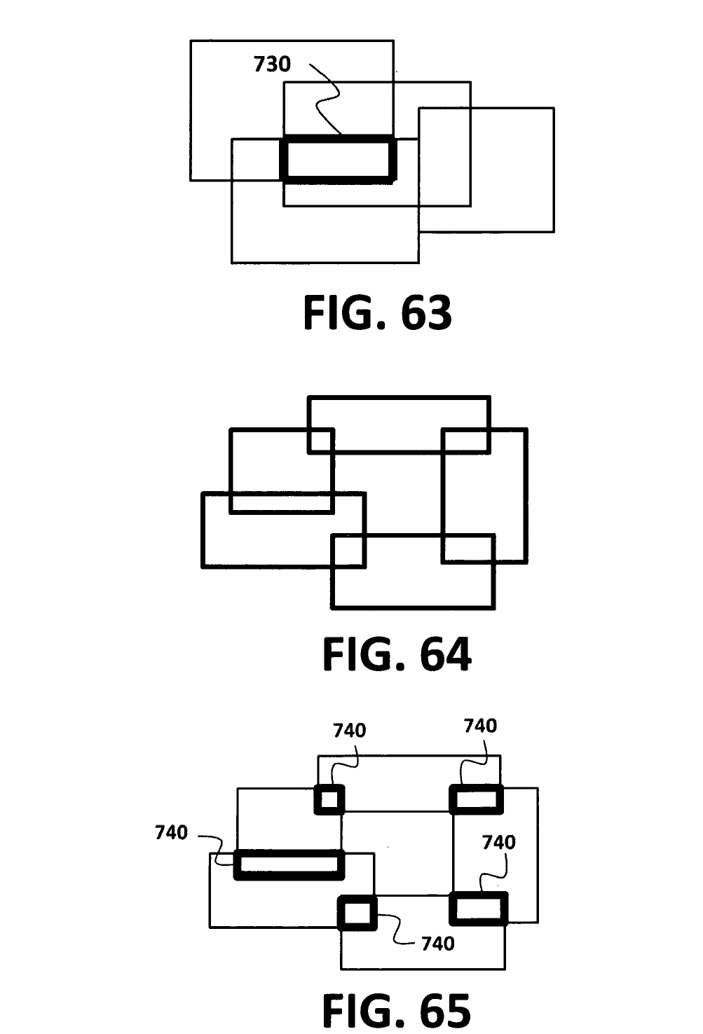

In another embodiment of the present invention, the area is represented by a plurality of successive joints. Accordingly, to find out a certain area in a drawing that meets certain criteria we need to figure out the joints that this area is comprised of FIG. 60 illustrates a plurality of polygons 700 overlapping with each other where it is requested to find each area in the drawing that is not an intersection area and forms an L-shape. In this case, when using the present invention, these areas can be defined as the polygon parts that are located outside the intersection areas and have six corners where the successive lines between these corners form two groups of parallel lines, as indicated with thick lines 710 in FIG. 61. In the case of requesting to find each intersecting area between two polygons in FIG. 60 that form a rectangle, these areas can be defined as the intersection area between each of the two polygons that have four corners where the successive lines between these four corners form two parallel groups of lines, as indicated with the thick lines in FIG. 62. In the case of requesting to find each intersection area in FIG. 60 that is completely surrounded by other intersection areas, this area can be defined as the intersection area that has each of its boundary joints as a boundary joint in another intersection area, as indicated with the thick lines 730 in FIG. 63.

In our daily life we may find difficulty to describe some types of drawing elements while talking with others, in such cases, we highlight an example of these elements on a drawing or a sketch where the other person usually visually understands what we mean. The present invention enables automating this process where manually highlighting parts of a drawing on a computer display enables the computer system to recognize these drawing parts and automatically generate a text describing these parts. Generally, this automated process dramatically facilitates the interaction between the user and the computer. For example, FIG. 64 illustrates a drawing presented on the computer display while FIG. 65 illustrates manually highlighting certain lines 740 in this drawing. Using the present invention enables the computer system to automatically describe these lines as “boundary lines of intersection areas of two polygons”. This automated description is achieved by comparing the joint IDs of these lines relative to the other joints of the drawing. As shown in the figure, the joints of these lines are boundary joints or corner joints of intersection areas and include two names which is unique from the other joints of the drawing, unique enough to automatically generate the aforementioned descriptive text.

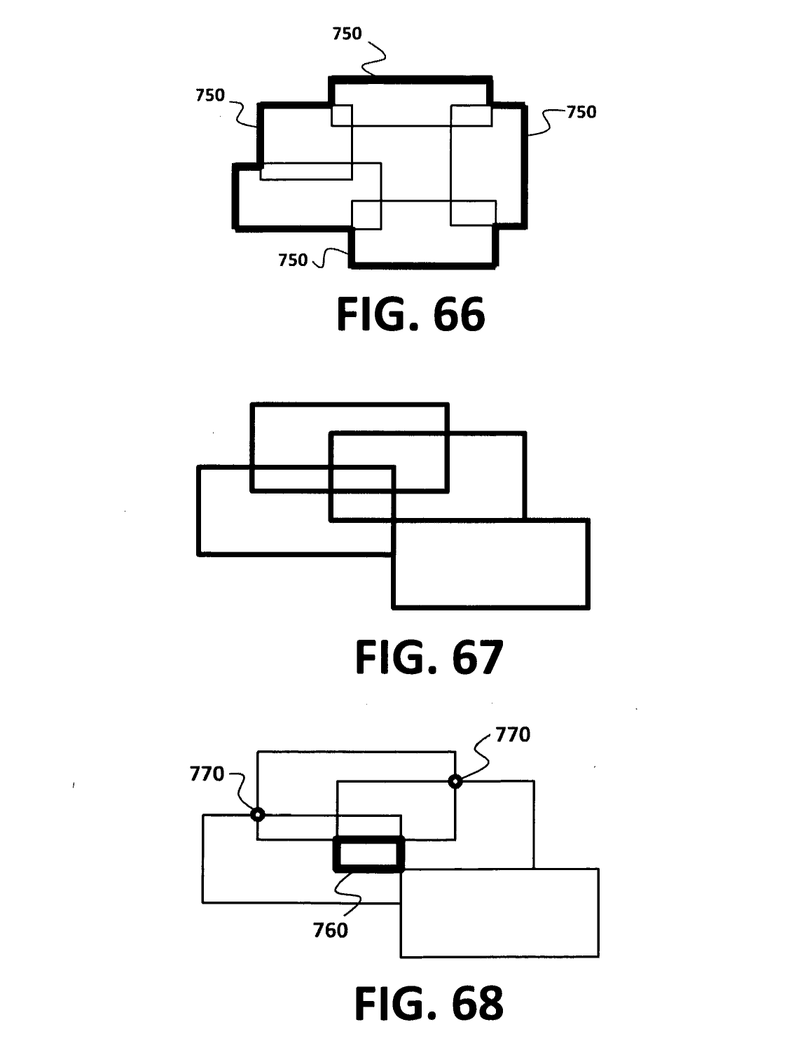

FIG. 66 illustrates another example of manually highlighting other lines 750 on the drawing of FIG. 64. In this case, when using the present invention, the computer system can automatically describe these lines as “Boundary lines of polygon clusters”. This automated description is achieved by comparing the joints IDs of these lines relative to the other joints of the drawing. As shown in the figure, the joints of these lines are boundary or corner joints of polygons and also boundary or corner joints of an exterior void where this information is enough to automatically generate the aforementioned descriptive text. Overall, the previous examples present simple cases of highlighting drawings where it is easy for a human to manually recognize the difference between the highlighted parts and the other drawing parts. However, there is another category of drawing highlighting that is hard to be manually recognized by a human where the difference between these highlighted parts and the other drawing parts is not very clear. On the other hand, when using the present invention the computer recognizes this category of drawing elements in a simple and fast manner without finding the same difficulties that a human may find.

For example, FIG. 67 illustrates a drawing comprised of a plurality of intersected rectangles while FIG. 68 illustrates a thick line 760 that is manually highlighted on this drawing on a computer display. As shown in the figure, this thick line looks like an intersection area between two polygons, but in fact there are other intersection areas in this drawing. In other words, the highlighted part in this drawing looks similar to the other drawing parts. However, in such cases, when using the present invention, the computer system defines the blue highlighted area as “an intersection area between two polygons that has no contact with the exterior void”. As mentioned previously, the exterior void means the empty area outside the cluster of polygons. Generally, as shown in FIG. 68 each one of the other intersection areas has one joint or corner that is attached to an empty joint, as indicated with the small circles 770, while the highlighted area does not have any of its joints attached to an empty joint. Such a minor difference is hard to be recognized by a human especially when dealing with complex engineering drawings.

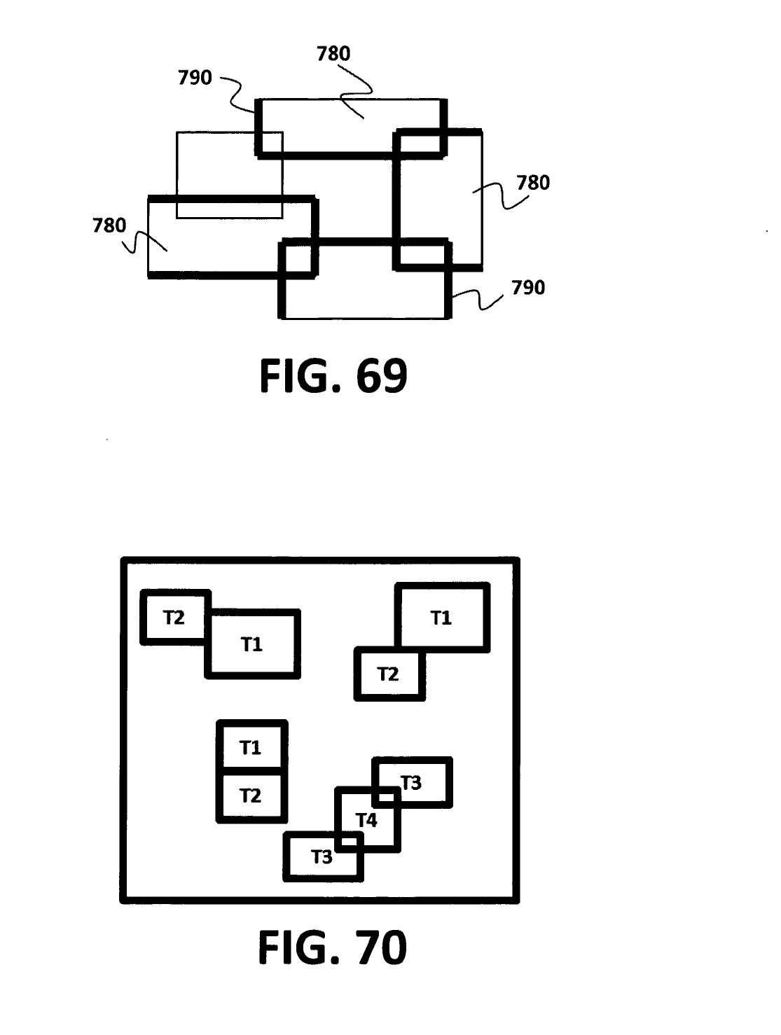

FIG. 69 illustrates another example of a drawing comprised of five rectangles 780 intersected with each other where a number of lines 790 are manually highlighted. As visually seen in this figure, it is not very obvious what makes these lines different from the other drawing lines. However, when using the present invention, the computer system will automatically describe these lines as “a set of lines devoid of a complete boundary line in a polygon that has one complete boundary line”. As shown in the figure, the highlighted line is not a complete boundary line, where part of it is located inside another polygon. In addition to that, each highlighted line is located in a polygon that has one line that is a complete boundary line that has no part of it located inside another rectangle. In fact this description clarifies why no lines of the white rectangle are highlighted in the drawing. Generally, in cases where the highlighting is performed manually on a drawing part that is not different from some other parts of the drawing, the computer automatically generates a message indicating this, while pointing out these other drawing parts that are similar to the highlighted part so the user can correct his/her manual highlighting.

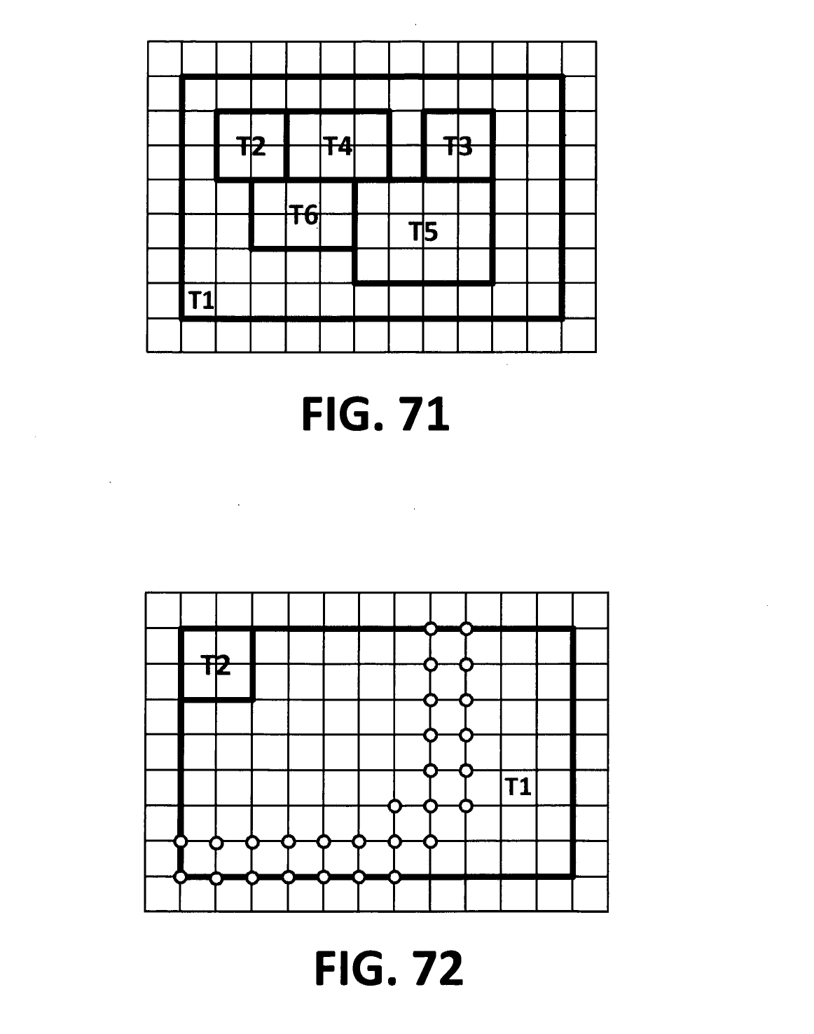

One of the common uses of the present invention is to check the positions of drawing objects relative to each other according to specific requirements, constraints, or rules. This is usually done during the actual drawing phase if the user prefers to check each step of the drawing process, or it can be done after finishing the drawing if the user prefers to hold the drawing check till the end of the drawing process. For example, FIG.70 illustrates an example of a drawing comprised of five types of objects T1, T2, T3, T4 and T5. These five types of objects should satisfy the following requirements: T1, T2, T3, and T4 should be located inside the limits of T5. T1 and T2 must be attached to each other. T3 and T4 must intersect with each other. Each T1 should be aligned horizontally or vertically with another T1. It is requested to find the algorithm that enables checking the aforementioned requirements in a drawing. In this case, when using the present invention, the first requirement of the problem “T1, T2, T3, and T4 should be located inside the limits of T5” can be achieved by the algorithm that states that the drawing joints that include T1, T2, T3, or T4 should also include T5. The second requirement of the problem “T1 and T2 must be attached to each other” can be achieved by the algorithm that states that at least one boundary joint or one corner joint of T1 includes T2, and no interior joint of T1 includes T2. The third requirement of the problem “T3 and T4 must be intersected with each other” can be achieved by the algorithm that states that one or more interior joints of T3 include T4. The fourth requirement of the problem “Each T1 should be aligned horizontally or vertically with another T1” can be achieved by the algorithm that states that at least one joint in T1 should have the same x- or y-coordinate of a joint in another T1. According to the previous algorithms, FIGS. 71 and 72 illustrate examples of two drawings that do not comply with the problem requirements but can be discovered automatically when using the present invention.

The present invention automates the process of generating a drawing that is comprised of a plurality of objects that are positioned relative to each other to comply with certain requirements or constraints. The major advantage of this process is providing the user with a number of design alternatives where the user can filter these design alternatives using more constraints or optimizing criteria. For example, when it is requested to find an algorithm for generating a drawing comprised of six rectangles, T1, T2, T3, T4, T5 and T6 that need to comply with the following requirements: T2, T3, T4, T5 and T6 are located inside the boundary lines of T1; the distance between T2 and T3 is greater than 3 feet and less than 6 feet; T5 has a direct view to the top and right lines of T1; the top border of T3 and T4 should be aligned with each other; T2, T3, T4, T5 and T6 cannot intersect with each other; T4 is attached to T2 and T6 in lines and T5 is attached to T3 and T6 in lines. In this case when using the present invention, a drawing such as the one shown in FIG. 71 will be automatically generated to satisfy the previous seven requirements of the problem.

Generally, the solution of this problem will include a grid description, object movement or placement on the grid, and position check for all objects relative to each other according to the problem requirements. For example, the grid description will be as follows: “a square grid will be utilized where each square is one foot by one foot. The total width and height of the grid will be the same width and height of T1. The object movement will be as follows: T1 will not be moved on the grid; T2, T3, T4, T5 and T6 will be moved successively on the grid vertices; starting with locating the top left corner of each one of them on the top left corner of T1, and ending with locating the bottom right corner of each one of them on the bottom right corner of T1. The position check will be as follows: the first requirement “T2, T3, T4, T5 and T6 are located inside the boundary lines of T1” will already be achieved by the algorithm of the object movement. The second requirement, “The distance between T2 and T3 is greater than 3 feet and less than 6 feet” will be achieved by the following algorithm: the distance between each border joint or corner joint of T3 and each border joint or corner joint of T2 is greater than 3 and less than 6 feet. The third requirement, “T5 has a direct view to the top and right lines of T1” will be achieved by the following two algorithms: at least one top border joint or top corner joint of T5 has a unique x-coordinate that no other border or corner joint of T2, T3, T4, T5 or T6 has it unless this other border or corner joint has a y-coordinate that is less than the y-coordinate of said top border joint or top corner joint of T5. At least one right border joint or right corner joint of T5 has a unique y-coordinate that no other border or corner joint of T2, T3, T4, T5 or T6 has it unless this other border or corner joint has an x-coordinate that is less than the x-coordinate of said right border joint or right corner joint of T5. The fourth requirement, “The top border of T3 and T4 should be aligned with each other,” will be achieved by the following algorithm: the x-coordinate of the top corner joints of T4 should be equal to the x-coordinate of the top corner joints of T3. The fifth requirement, “T2, T3, T4, T5 and T6 cannot intersect with each other” will be achieved by the following algorithm: no joint will include more than one of the following names of T2, T3, T4, T5, and T6. The sixth requirement, “T4 is attached to T2 and T6 in lines” will be achieved by the following two algorithms: at least two successive boundary or corner joints of T4 include the name of T2 and at least two successive boundary or corner joints of T6 include the name of T2. The seventh requirement, “T5 is attached to T3 and T6 in lines” will be achieved by the following two algorithms: at least two successive boundary or corner joints of T5 include the name of T3 and at least two successive boundary or corner joints of T6 include the name of T5.

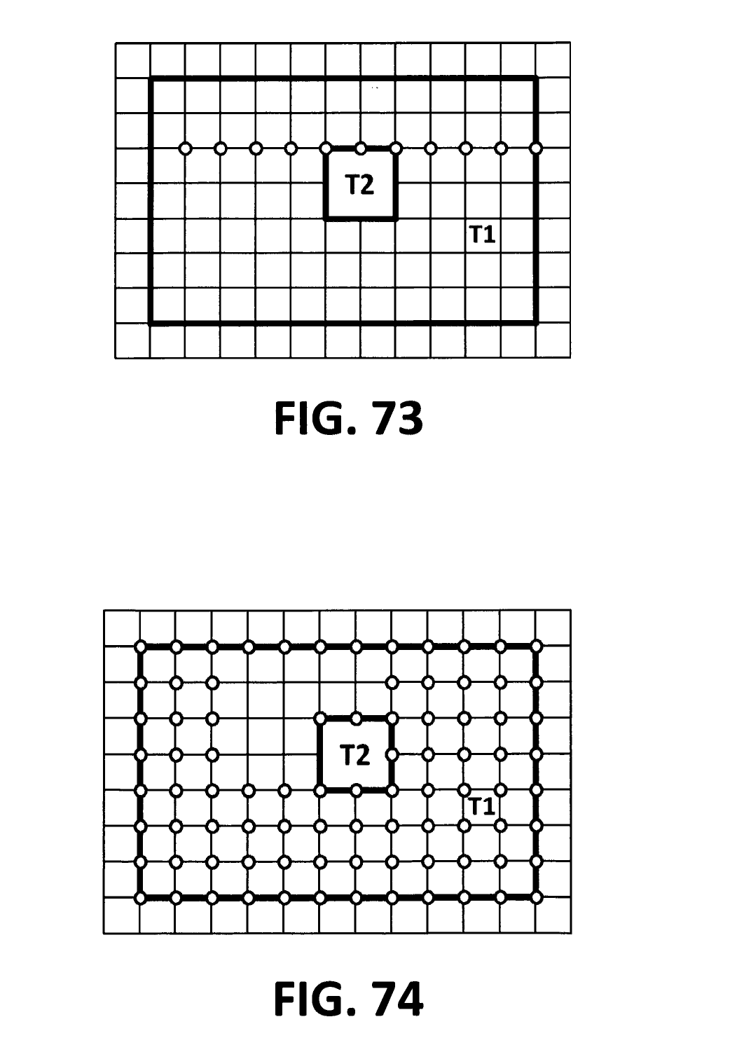

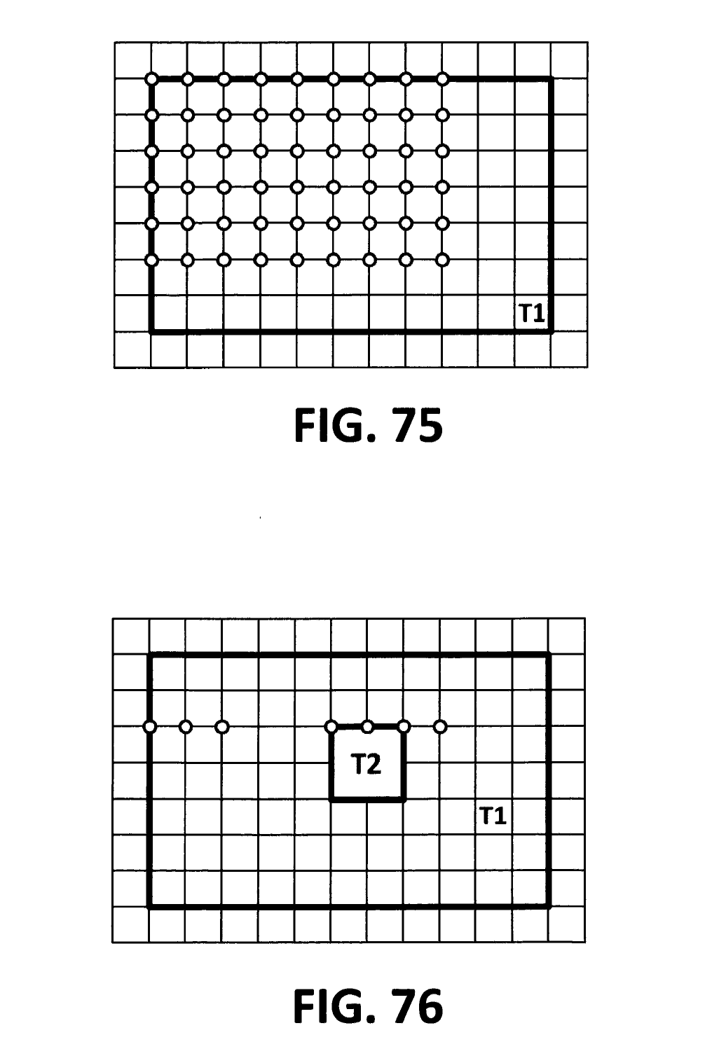

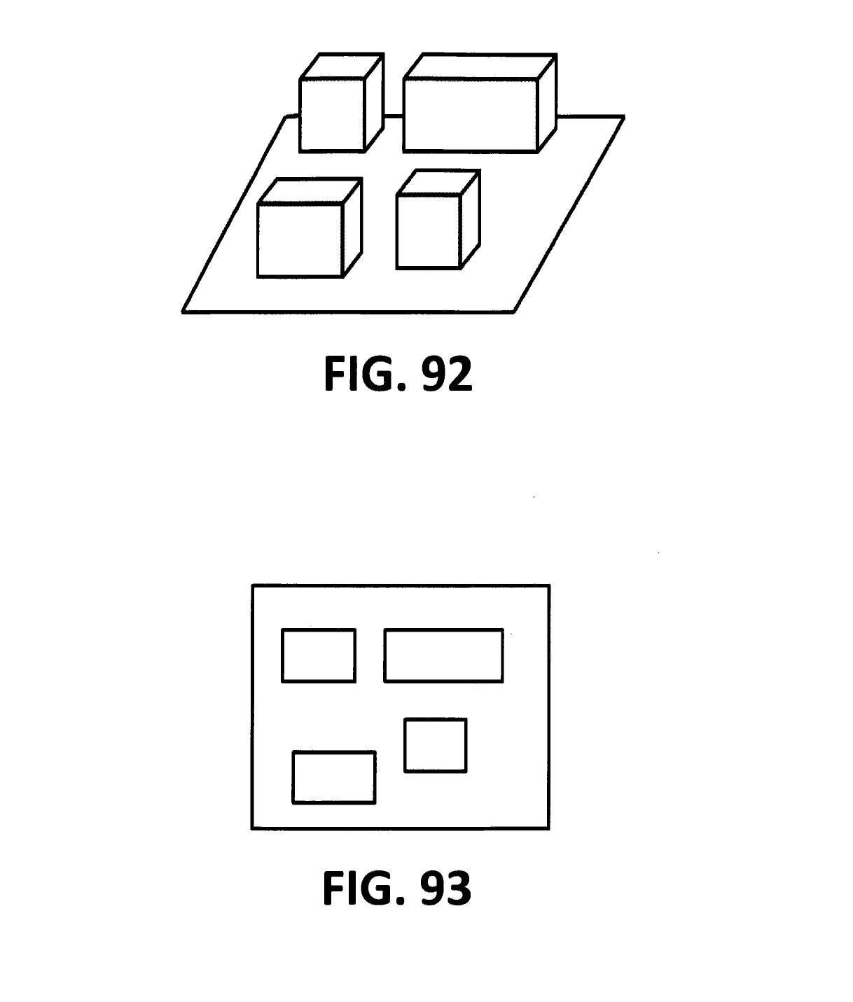

Generally, the previous algorithms enable positioning the six rectangles relative to each other to satisfy the problem requirements but in a way that is not optimized in regards to the time period of generating the solutions on the computer display as will be described in the following chapter. The solution or algorithms of the previous problem did not consider the speed of generating the drawing on the computer display where these algorithms can be replaced with more intelligent algorithms that save a large amount of time. Generally, the process of intelligent positioning simulates the intelligent steps of the method that professional designers use while solving such problems manually. For example, according to the previous algorithms, the top left corner of T2 will be positioned on the top left corner of T1, then T3 will be moved successively on the grid vertices where at each position of T3 the computer system will check if the distance between T3 and T2 is greater than 3 and less than 6. In fact, that will dramatically consume the time while it is more intelligent to determine in advance the set of grid vertices that T3 can be positioned on instead or positioning T3 on all vertices of the grid then checking at each position if it complies or not with the problem requirements. For example, FIG. 89 illustrates all joints where the distance between them and T2 is greater than 3 and less than 6 and where the top left corner of T3 can be positioned on these joints to satisfy the problem requirements. Such a process dramatically decreases the time spent in locating T3 relative to T2 especially in large or complex engineering drawings. Other algorithms of the previous problem can also use the same concept of specifying a set of the grid joints that an object can be located on instead of locating this object on all grid vertices. For example, FIG. 72 illustrates a set of joints where the left corner of T4 can be positioned on them to be aligned with the top border of T3. However, some of these grid joints are not valid for T4 where positioning the top left corner of T4 on them will lead to an intersection between T3 and T4, or locating T4 outside the limits of T1. To solve this conflict FIG. 91 eliminates the grid joints that lead to an intersection between T3 and T4, while FIG. 92 eliminates the grid joints that lead to positioning part of T4 outside T1. Accordingly, by combining the grid joints of FIGS. 73, 74 and 75, a new set of joints are specified where these new set of joints are the right grid joints for positioning the top left corner of T4 to satisfy the problem requirements as illustrated in FIG. 76.

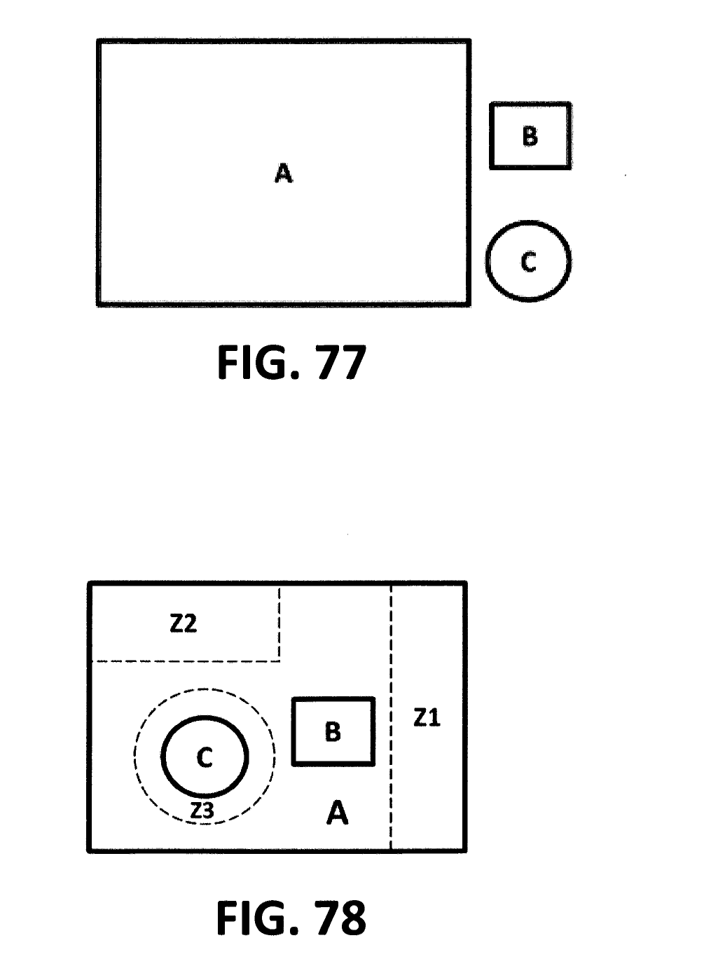

Generally, there is a type of objects called “imaginary objects” that can indirectly be defined from the problem requirements. This is opposite to the original objects of the drawing or 3D model that are directly given in the problem statement. Generally, the imaginary objects can be classified into three categories: fixed objects; variable objects; and polymorphic objects. The following example presents requirements of a problem that indirectly indicate a number of fixed imaginary objects. FIG. 77 illustrates three objects: A; B; and C. These objects should be positioned relative to each other according to the following requirements: B and C should fit inside A; B and C should be located at least 5 units away from the right border of A; B should be located at least 6 units away from the left half of the top border of A; and B should be located at least 2 units away from C. FIG. 78 illustrates three zones: Z1; Z2; and Z3 representing three fixed objects indicated in the problem requirements. Z1 represents the area indicated in the second requirement of the problem that locates B and C at least 5 units away from the right border of A. Z2 represents the area indicated in the third requirement of the problem that locates B at least 6 units away from the left half of the top border of A. Z3 represents the area indicated in the fourth requirement of the problem that locates B at least 2 units away from C. Accordingly, the problem includes three original objects A, B, and C in addition to another three imaginary objects Z1, Z2, and Z3. Therefore, the problem requirements can be transformed into the following: B and C should be located inside A; B cannot intersect with C, Z1, Z2, and Z3; and C cannot intersect with B, Z1 and Z2. In this case, the grid joints that include Z1 and Z2 will be defined one time since Z1 and Z2 will not change their position on the grid, while the grid joints that include Z3 will be defined with each position or movement of C on the grid vertices. Overall, the major advantage of defining the fixed objects is converting the problem requirements into direct statements related to a number of well-defined objects that have certain positioning relationships relative to each other.

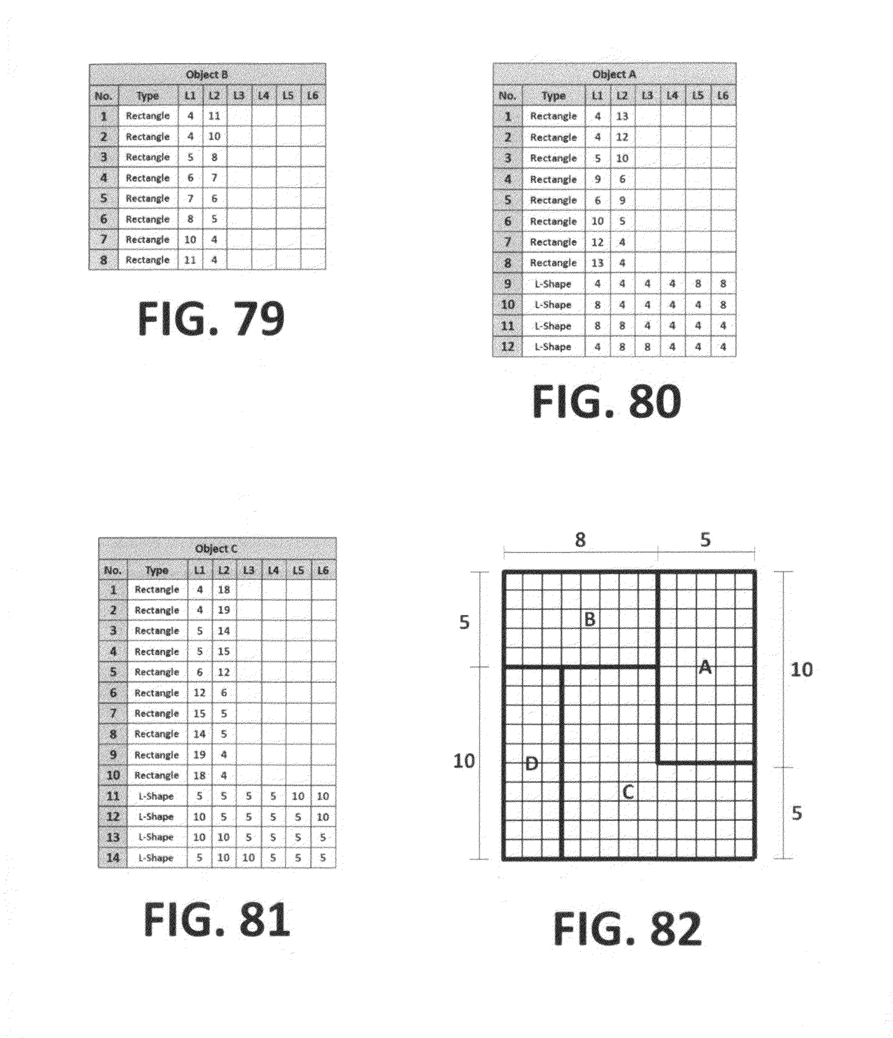

The variable objects are the objects that can be formed by a number of different shapes or a number of different areas. The following example presents requirements of a problem that indicate three variable imaginary objects: A, B, and C are three objects where each one of them can be in the form of a rectangle or L-shape. The minimum and maximum allowed area of A, B and C are successively 48-54, 40-44 and 70-77, where no dimension of these three objects can be less than 4 units. The three objects are required to fit with all possible alternatives, without intersection between them, inside another object D which is a rectangle with a length of 15 units and width of 13 units. As described in this problem, each one of the three objects A, B and C has a number of different shapes and different areas, accordingly they are all considered variable objects. To convert the problem statement into a direct statement each one of the variable objects will be converted into a number of fixed objects as shown in the tables of FIGS. 79 to 80. For example, FIG. 79 presents the alternative of A as rectangles and L-shapes on a square grid. Also FIG. 80 presents the alternative of B as rectangles where it cannot be in a form of an L-shape according to its dimensional restrictions, while FIG. 81 presents the alternatives of C as rectangles and L-shapes. As can be observed in these tables, the dimension of each grid square is 1×1 unit. Generally, the fixed objects of A, B and C that are indicated in the tables are the objects that will be used in solving the problem where each one of the alternative solutions will include different combinations of A, B and C taken from the three tables. FIG. 82 illustrates a solution example for the problem that utilized the alternative No. 3 of A, the alternative No. 6 of B and the alternative No. 11 of C of the three tables.

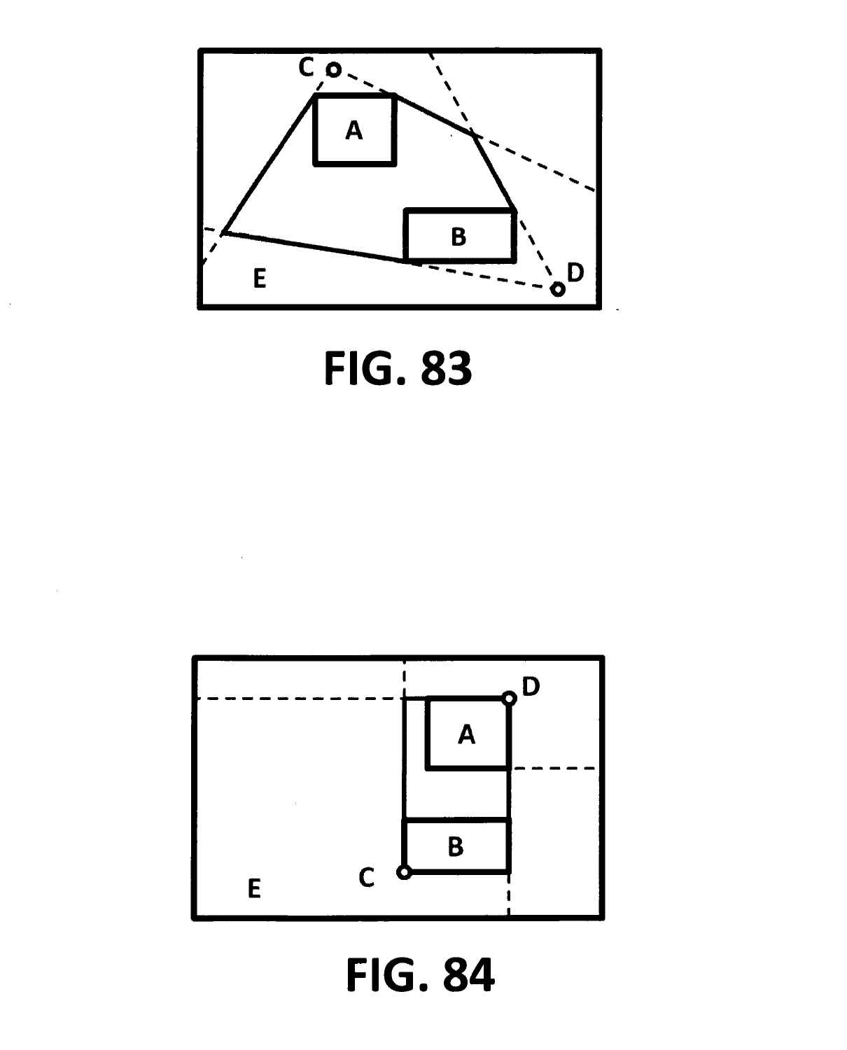

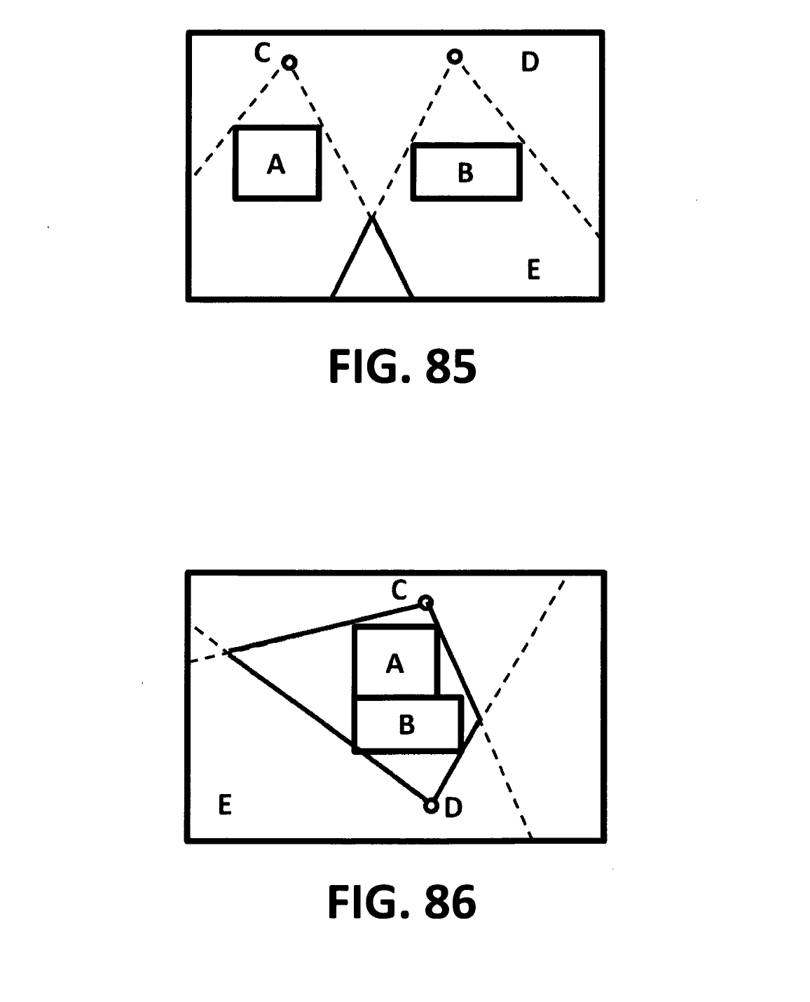

The polymorphic objects are the objects that can take different shapes or areas where these different shapes or areas cannot be defined from the problem statement. The following example presents requirements of a problem that indicates polymorphic imaginary objects. A and B are two rectangles while C and D are two light sources. A, B, C and D are to be placed at any positions inside rectangle E. Find the different positions of A, B, C and D that create a dark area inside E that forms one or more L-shapes or triangles. FIG. 83 illustrates randomly positioning A, B, C and D inside E where the highlighted red lines represent the boundaries that separate the light area from the dark area according to the two light sources. As shown in this figure, the black lines are forming a polygon representing the dark area inside E. However, this polygon is an example of a polymorphic object that can take different shapes and areas that cannot be defined from the problem statements. However, the dark area in this example does not form an L-shape or a triangle which does not satisfy the problem requirements or solution although this dark area is still an imaginary polymorphic object. FIGS. 84 to 86 illustrate three polygons of dark areas that form three polymorphic objects that satisfy the problem requirements. As shown in the three figures, the dark areas successively form an L-shape, one triangle and five triangles accordingly they are considered three examples of the problem solutions. Generally, this problem represents a type of simulation problem where parameters of a polymorphic object are figured out according to the movement of other objects using the present invention.

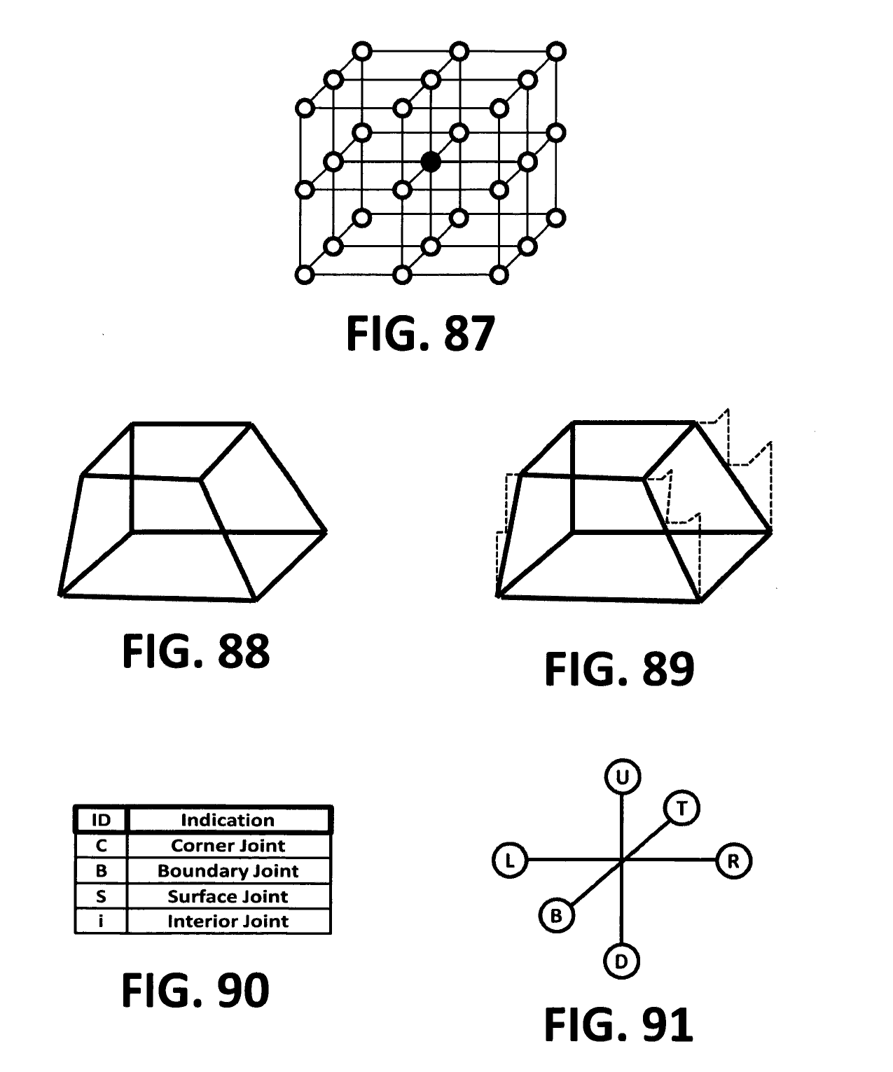

The main difference between 3D modeling and 2D modeling is the third dimension, where considering the third dimension when using the present invention is quite simple. Generally, the following description indicates the impact of the third dimension on different 2D topics that were discussed previously. The 3D grid is a plurality of 3D units that are repeated in three dimensions in a certain fashion. The most common unit for the 3D grid is the cube where each cube can be attached to another 8 cubes from its 8 surfaces. When using the square as a grid unit in 2D grids, each grid joint is surrounded by another 8 joints, while in 3D grids when using the cube as a grid unit, each grid joint is surrounded by 26 joints as illustrated in FIG. 87 with the highlighted red circles. If a line of a 3D drawing is aligned with the lines of the 3D grid then this line is represented by the grid vertices that are located on it. If a line of a 3D drawing is not aligned with the lines of the 3D grid then line is represented by the closest grid vertices to it. For example, FIG. 88 illustrates a 3D drawing where some lines of this drawing are not aligned with the 3D grid. FIG. 89 illustrates converting each unaligned line into a number of new lines that are aligned to the grid, where these new lines can be represented by the grid vertices that are located on them. Accordingly, it becomes possible to represent the 3D drawing with a plurality of the 3D grid vertices. As shown in the figure, each unaligned line can be represented by two or three lines according to its slope relative to the x-, y- and z-axis. FIG. 90 presents a table indicating the main IDs of the 3D grid joints. As shown in the table, there is a new ID representing a surface joint which is tagged with “S”. These surface joints do not exist in 2D modeling while the corner, boundary, and the inner joints are similar to the IDs found within 2D modeling.

The additional IDs of the 3D shapes are different than the additional IDs found within 2D modeling or polygons since in 3D there are six main directions as illustrated in FIG. 91, which are “T” top, “B” bottom, “R” right, “L” left, “U” up, and “D” down. Accordingly, there are 16 additional IDs for the 3D corner joints as follows: UTR; URB; UBL; ULT; DTR; DRB; DBL; DLT; −UTR; −URB; −UBL; −ULT; −DTR; −DRB; −DBL; and −DLT. Also there are 12 additional IDs for the boundary joints as follows: UT; UR; UB; UL; DT; DR; DB; DL; TL; TR; RB; and BL. There are an additional 6 IDs for the surface joints as follows: T; R; B; L; U; and D. The inner joints have no additional IDs as usual. Generally, the joints of the 3D model or objects include the name of the object, the basic ID and the additional ID similar to the 2D objects or polygons.

Generally, if two 3D shapes intersect or attach to each other, the joints that are located in the intersection volume or in the attachment area change their basic IDs and additional IDs according to the names of the 3D shapes. In other words, if the two 3D shapes have the same name, then these 3D shapes will be combined together into one 3D shape, while if the two 3D shapes have different names, then these 3D shapes will form a new intersection volume or attachment area with new IDs. Similar to 2D modeling, the voids in 3D are classified into interior voids and exterior voids. The interior void is a void that is completely surrounded by 3D objects, while the exterior void is a void that surrounds the 3D objects. The composition list of the 3D model includes the corner, boundary and inner joints of the following elements: objects, intersections, outside intersections, attachment lines, attachment volumes, attachment points, interior voids, exterior voids, and object clusters. Similar to the 2D model, the 3D imaginary objects of the 3D model can be classified into fixed objects, variable objects and polymorphic objects. The only difference between the 3D imaginary objects and the 2D imaginary objects is the third dimension of the 3D imaginary objects. The 3D problems that include 3D objects can be categorized into three types: (1) 3D problems that can be represented on a 2D grid; (2) 3D problems that can be represented on layers of 2D grids; and (3) 3D problems that must be represented on a 3D grid. For example, FIG. 92 illustrates a number of 3D objects with the same height where these 3D objects can only be moved on a horizontal plane. If the positioning of the 3D object is always on the horizontal plane where these 3D objects can only be moved along the x- or y-axis, such 3D objects can be represented by a 2D drawing as illustrated in FIG. 93. Accordingly, there is no need to utilize a 3D grid for such 3D objects where the 2D grid is enough to represent the different alternatives of the 3D objects' positions or movements on the xy-plane.

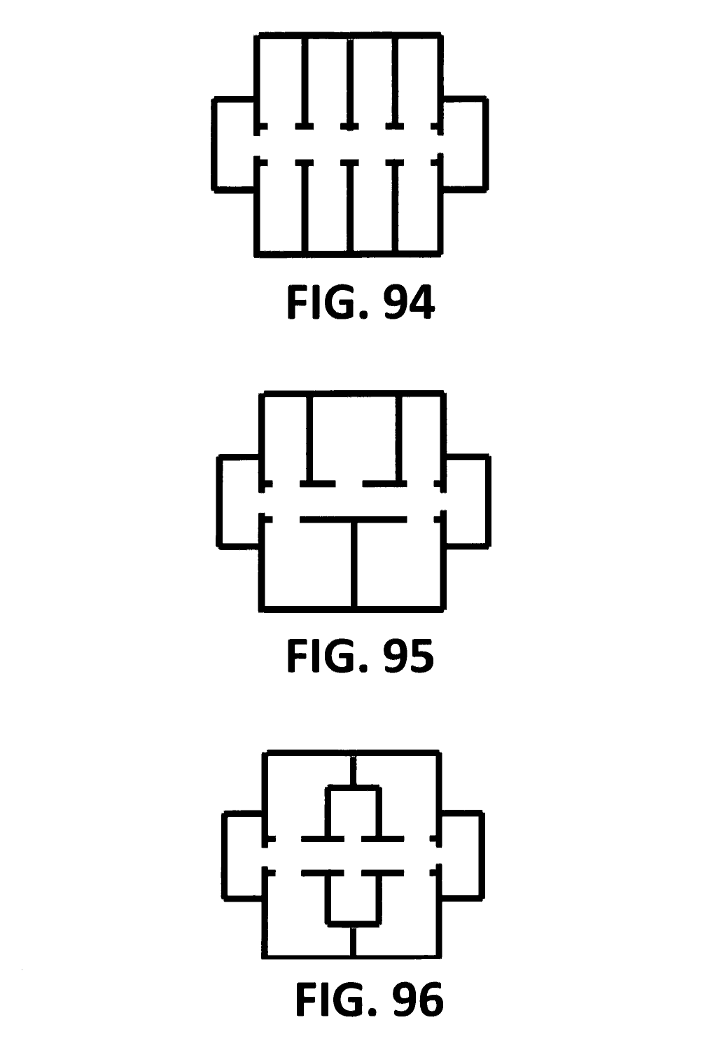

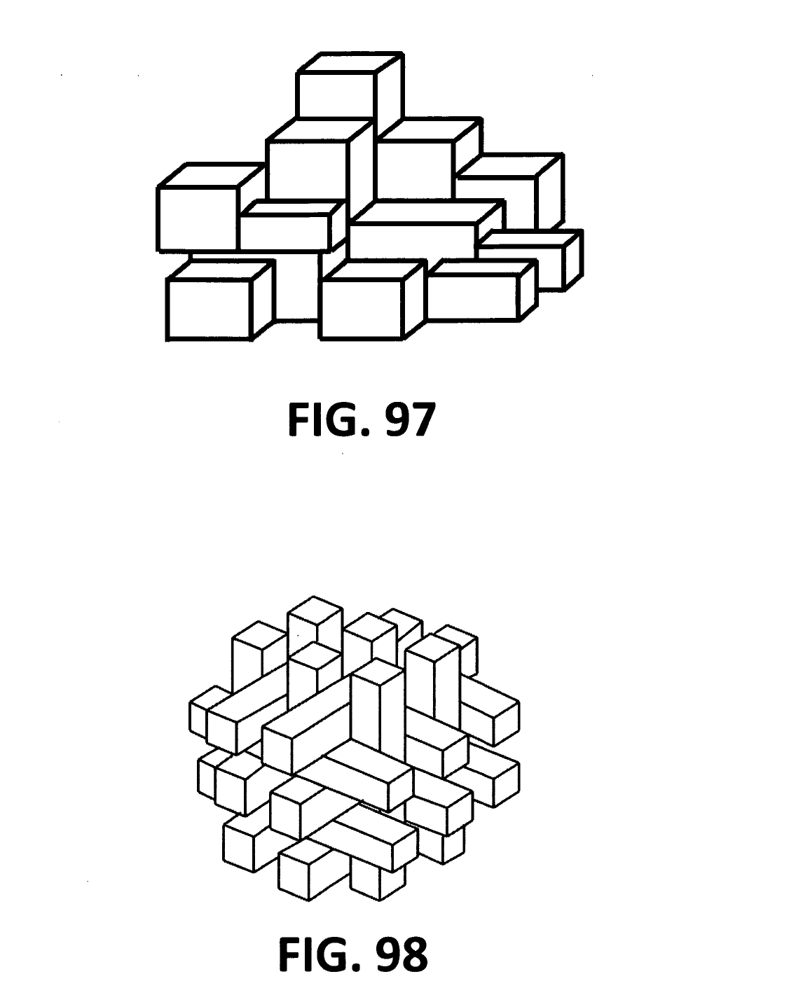

The second type of 3D problem involves 3D objects that can be represented by layers of 2D grids similar to the way the architect designs multi-floor buildings where each architectural space is positioned in a certain floor. In this case, the building can be represented by a number of 2D plans where each one of these 2D plans represents architectural spaces that are located in this plan or floor. For example, FIGS. 94 to 96 illustrate three plans representing three floors of a building where each architectural space in these plans represents a 3D object. In such cases, each plan can be represented by a 2D grid since each architectural space can only be positioned or moved along the x- or y-axis in this plan or floor. Generally, in such 3D problems the 2D grids or floors are not completely separated from each other, where in most cases these are some alignment requirements for 3D objects in different floors. For example, some types of 3D objects should be located on top of each other in different floors while other types of 3D objects should not be located on top of each other in different floors. The third type of 3D problem that must be represented on a 3D grid is when the 3D objects can be located or moved in three-dimensions along the x-, y-, and z-axis. For example, FIG. 97 illustrates a plurality of 3D objects that are attached to each other whereas these 3D objects are not located on one plane and cannot be located on a certain number of floors or planes. Accordingly, in such cases a 3D grid is utilized.

In comparison to the 2D models, the details of the 3D models are not visually clear to the human eye in most cases. For example, FIG. 98 illustrates a plurality of prisms that are attached to each other; the details of this 3D model are not readily visible to us even if we rotated this 3D model on the computer display, or if we cut this 3D model into horizontal and vertical sections. On the other hand, when using the present invention, the details of such a complex 3D model can be simply recognized in an automated manner. For example, to define the surfaces of this 3D model that have exterior exposure, the computer system will only define the corner, boundary and surface joints that are attached to an empty joint. Also, to define the volume of this 3D model that has no exterior exposure, the computer system will only define the corner, boundary and surface joints that are not attached to an empty joint. Such surfaces are not easy to be manually defined when dealing with complex 3D models. Overall, one of the major advantages of using the present invention is extracting information from a 3D computer model that is hard to be visually or manually recognized or extracted. For example, if the 3D model of FIG. 98 is positioned in a manner so that it may be exposed to the sunlight in a certain location at a certain time of the year, the shade and shadow of this 3D model can be calculated in great detail using the present invention, while visually or manually this shade or shadow can only be viewed without extracting any numerical information from the 3D model. Moreover, if this shade or shadow is calculated every hour of the year, meaning 8760 different positions for the sun, the present invention can give us the results in a very short time.

1. A method for representing a virtual model wherein said method comprises:
representing each line of said virtual model with a plurality of joints;
defining the corner joints of said plurality of joints that are located at the start point and end point of each line;
defining the boundary joints of said plurality of joints that are located between the start point and the end point of each line;
defining the inner joints of said plurality of joints that are located between each two successful boundary joints inside said virtual model; and,
giving an identifier for each joint of said corner joints, said boundary joints and said inner joints representing its position relative to other joints.

2. A method for representing a virtual model wherein said method comprises:
defining the polygons of said virtual model;
defining the parts of said polygons that intersect with each other;
defining the parts of said polygons that do not intersect with each other;
defining the parts of said polygons that represent a hole or void; and,
defining each plurality of said polygons that represent a cluster or group of polygons.

3. A method for representing a virtual model wherein said method comprises:
transforming said virtual model into a plurality of joints;
tagging each joint of said plurality of joints with an identifier representing a polygon name;
tagging each joint of said plurality of joints with an identifier representing its position relative to a certain direction; and, tagging each joint of said plurality of joints with an identifier representing its position relative to the other joints that surround it.

4. The method of claim 1 wherein said virtual model is a two-dimensional model.

5. The method of claim 1 wherein said virtual model is a three-dimensional model.

6. The method of claim 1 wherein said virtual model is a plurality of two-dimensional models located in different layers that have different heights.

7. The method of claim 2 wherein said parts of said polygons are areas.

8. The method of claim 2 wherein said parts of said polygons are lines.

9. The method of claim 2 wherein said parts of said polygons are points.

10. The method of claim 3 wherein said name is a number.

11. The method of claim 3 wherein said direction is the North, South, East, West, Northeast, Southeast, Northwest or Southwest direction.

12. The method of claim 3 wherein said form of joints are joints in the North, South, East, West, Northeast, Southeast, Northwest or Southwest direction.
